(19) United States
(12) Patent Application Publication
(10) Pub. No.: US 2025/0116265 A1
(43) Pub. Date: Apr. 10, 2025

(54) RECIPROCATING COMPRESSOR

(71) Applicant: LG Electronics Inc., Seoul (KR)

(72) Inventor: Kyoungjun PARK, Seoul (KR)

(21) Appl. No.: 18/887,725

(22) Filed: Sep. 17, 2024

(30) Foreign Application Priority Data
Oct. 4, 2023 (KR) 10-2023-0131806

(51) Int. Cl. F04B 39/10; F04B 53/10

(52) U.S. Cl. CPC F04B 39/1073; F04B 39/1066; F04B 53/1052

(57) ABSTRACT

A reciprocating compressor includes a shell, a driving motor, a drive shaft, a piston, a cylinder, a valve plate, a suction valve, and a suction valve stopper. The suction valve stopper is made of an elastic member and disposed between the suction valve and the cylinder to support a reed valve portion of the suction valve and limit an opening amount of the reed valve portion. The opening amount is controlled to increase cooling power in a high load operation area and prevent dead volume to thereby increase energy efficiency in a low load operation area and a high load operation area.

### CROSS-REFERENCE TO RELATED APPLICATION

Pursuant to 35 U.S.C. § 119 (a), this application claims the benefit of the earlier filing date and the right of priority to Korean Patent Application No. 10-2023-0131806, filed on Oct. 4, 2023, the contents of which are incorporated by reference herein in their entirety.

### TECHNICAL FIELD

This disclosure relates to a reciprocating compressor.

### BACKGROUND

Compressors may be classified into a hermetic compressor in which a motor unit and a compression unit are included together inside a shell, and an open-type compressor in which a motor unit and a compression unit are included separately. The present disclosure is described mainly about the hermetic compressor, but may be applied identically to the open-type compressor.

In some cases, compressors may be classified into a reciprocating type, a rotary type, a vane type, a scroll type, and the like according to a method of compressing refrigerant. A rotary compressor, a vane compressor, and a scroll compressor each have a suction valve and a discharge valve separately, whereas a reciprocating compressor has a suction valve and a discharge valve integrated into one assembly.

In some examples, where the reciprocating compressor includes a suction valve and a discharge valve separate from each other, since a valve installation space is relatively large, a degree of design freedom for these valves may be high, but a number of assembly processes may increase. In some examples, where a suction valve and a discharge valve are included as one assembly, since a valve installation space is small, a degree of design freedom for these valves may be low, but a number of assembly processes may be reduced.

In some cases, a reciprocating compressor may include one valve assembly integrally constituted by a suction valve and a discharge valve. The suction valve may cut from a suction valve seat made of an elastic member to have a cantilever shape, but may not include a structure of limiting an opening amount of the suction valve. Accordingly, in some cases, there is a risk of fracture due to excessive leaning back of the suction valve during high-pressure and/or high-speed operation.

In some cases, a reciprocating compressor may include a structure of limiting an opening amount of a suction valve. For instance, a separate valve seat plate is included between a cylinder and a suction valve, and a step groove is disposed in the valve seat plate to limit an opening amount of the suction valve. In some cases, a step groove for supporting an opening/closing end of a suction valve is disposed in a front-end surface of a cylinder to limit an opening amount of the suction valve.

In some cases, where an opening amount of a suction valve is limited using a rigid member, an opening amount of the suction valve may be excessively limited. As a result, an amount of refrigerant suctioned into a compression chamber may be decreased, thus deteriorating efficiency of a compressor, as well as reducing maximum cooling power.

In some cases, a step surface for limiting an opening amount a suction valve may result in dead volume, thereby worsening compression efficiency. In some cases, the dead volume may be further increased in correspondence with a suction passage in a valve seat plate.

### SUMMARY

The present disclosure describes a reciprocating compressor having a small size and capable of performing high load operation.

The present disclosure further describes a reciprocating compressor capable of properly limiting an opening amount of a suction valve according to an operation range.

The present disclosure further describes a reciprocating compressor capable of limiting an opening amount of a suction valve while securing a sufficient opening amount of the suction valve.

The present disclosure further describes a reciprocating compressor capable of securing a sufficient opening amount of a suction valve while suppressing a damage to the suction valve.

The present disclosure further describes a reciprocating compressor capable of securing a sufficient opening amount of a suction valve while allowing the suction valve to be quickly closed.

The present disclosure further describes a reciprocating compressor capable of limiting an opening amount of a suction valve while suppressing generation of dead volume due to the limiting.

The present disclosure further describes a reciprocating compressor capable of simplifying members configured to limit an opening amount of a suction valve.

According to one aspect of the subject matter described in this application, a reciprocating compressor includes a shell that defines an inner space therein, a driving motor disposed in the inner space of the shell, the driving motor including a rotor, a drive shaft coupled to the rotor of the driving motor, a piston coupled to the drive shaft and configured to perform a reciprocating motion, a cylinder that accommodates the piston and defines a compression chamber together with the piston inserted in the cylinder, where the piston is configured to perform the reciprocating motion relative to the cylinder, a valve plate that is coupled to a front-end surface of the cylinder and faces the piston, the valve plate defining a suction port and a discharge port that are configured to fluidly communicate with the compression chamber, a suction valve disposed between the cylinder and the valve plate, the suction valve including a reed valve portion configured to open and close the suction port based on an end of the reed valve portion moving relative to another end of the reed valve portion, and a suction valve stopper disposed between the suction valve and the cylinder, the suction valve stopper being made of an elastic member and configured to interfere with the reed valve portion to thereby limit an opening amount of the reed valve portion. Accordingly, an opening amount of the suction valve may be sufficiently secured to increase cooling power in a high-load operation area, and prevent dead volume in advance to increase energy efficiency in a low-load operation area and/or a high-load operation area.

Implementations according to this aspect can include one or more of the following features. For example, a rigidity of the suction valve stopper may be greater than or equal to a rigidity of the suction valve. Accordingly, when the suction valve is opened or closed, the suction valve stopper may elastically limit an opening/closing operation of the suction valve.

In some examples, the suction valve stopper may include at least one stopper portion that extends toward a radial center of the suction port and overlaps with a side surface of the reed valve portion, where at least a portion of the at least one stopper portion is bent in a direction away from the reed valve portion and spaced apart from the reed valve portion. Accordingly, an opening amount of the suction valve may not be limited or may be passively limited in low load operation, whereas an opening amount of the suction valve is actively limited in high load operation to prevent the reed valve portion of the suction valve from being excessively bent.

In some examples, the at least one stopper portion may include a fixing portion fixed to the front-end surface of the cylinder and disposed at a radial outer periphery of the compression chamber, a bent portion that extends from the fixing portion toward the radial center of the suction port and is bent toward the compression chamber in the direction away from the reed valve portion, and a contact portion that extends from the bent portion and is configured to contact the reed valve portion based on the reed valve portion being opened, where the bent portion is disposed radially between an inner circumferential surface of the compression chamber and an outer circumferential surface of the reed valve portion. Accordingly, an edge of the suction valve in contact with the front-end surface of the cylinder may be suppressed from being lifted by the bent portion, and the reed valve portion of the suction valve may be suppressed from being in contact with the bent portion to thereby stably limit an opening amount of the suction valve.

In some examples, a distance from the bent portion to an end of the contact portion is less than a length of the reed valve portion. Accordingly, rigidity of the stopper portion may be greater than that of the reed valve portion of the suction valve, and thus, the stopper portion may stably limit an opening amount of the suction valve.

In some implementations, the suction valve stopper defines a valve accommodating portion that faces the reed valve portion and passes through the suction valve stopper, where the contact portion is accommodated in the valve accommodating portion. By doing so, the contact portion of the stopper portion may overlap the reed valve portion of the suction valve in a reciprocating direction of the piston to elastically support the reed valve portion of the suction valve.

According to another aspect, A reciprocating compressor includes a piston, a cylinder that accommodates the piston and defines a compression chamber together with the piston inserted in the cylinder, where the piston is configured to reciprocate relative to the cylinder, a valve plate that is coupled to a front-end surface of the cylinder and faces the piston, the valve plate defining a suction port and a discharge port that are configured to fluidly communicate with the compression chamber, a suction valve including (i) a valve fixing portion disposed between the cylinder and the valve plate and coupled to the cylinder and (ii) a reed valve portion configured to open and close the suction port, the reed valve portion having a first end extending from the valve fixing portion and a second end configured to open and close the suction port, and a suction valve stopper disposed between the suction valve and the cylinder and configured to limit an opening amount of the suction valve. Thus, excessive opening of the reed valve portion of the suction valve may be suppressed.

Implementations according to this aspect can include one or more of the following features. For example, the suction valve stopper may include a stopper fixing portion coupled to the cylinder together with the valve fixing portion, and at least one stopper portion that extends from the stopper fixing portion toward a radial center of the suction port and at least partially overlaps with the reed valve portion along a reciprocating direction of the piston. Accordingly, when the reed valve portion of the suction valve is opened, the at least one stopper portion may be brought into contact with the reed valve portion to limit an opening amount of the suction valve.

In some examples, the stopper portion may include a first stopper portion disposed at a first side of a longitudinal axis of the reed valve portion, and a second stopper portion disposed at a second side of the longitudinal axis of the reed valve portion and spaced apart from the first stopper portion, where the first stopper portion and the second stopper portion are symmetrical to each other with respect to the longitudinal axis of the reed valve portion. Accordingly, the first stopper portion and the second stopper portion may be easily manufactured, and the first stopper portion and the second stopper portion may symmetrically support the reed valve portion of the suction valve. Thus, an opening amount of the suction valve may be stably supported.

In some examples, the first stopper portion and the second stopper portion extend in a direction perpendicular to the longitudinal axis of the reed valve portion. By doing so, rigidity of the first and second stopper portions may be maintained properly so that the first and second stopper portions may stably support the reed valve portion of the suction valve on both sides.

In some implementations, the radial center of the suction port is disposed at a position eccentric with respect to a radial center of the compression chamber, where the reed valve portion extends along the longitudinal axis from an outside of the suction port toward the radial center of the suction port in a radial direction, and the first stopper portion and the second stopper portion are disposed at positions eccentric with respect to the radial center of the compression chamber in the radial direction. By doing so, lengths of the first stopper portion and the second stopper portion may be configured to be respectively smaller than a length of the reed valve portion of the suction valve, thereby increasing rigidity to stably limit an opening amount of the reed valve portion of the suction valve.

In some implementations, the first stopper portion may include a first fixing portion that extends from a first side of the stopper fixing portion and is fixed to the front-end surface of the cylinder, the first fixing portion being disposed at a radial outer periphery of the compression chamber, a first bent portion that extends from the first fixing portion toward the radial center of the suction port and is bent toward the compression chamber in a direction away from the reed valve portion, and a first contact portion that extends from the first bent portion and is configured to contact one side of the reed valve portion based on the reed valve portion being opened. The second stopper portion may include a second fixing portion that extends from a second side of the stopper fixing portion and is fixed to the front-end surface of the cylinder, the second fixing portion being disposed at the radial outer periphery of the compression chamber, a second bent portion that extends from the second fixing portion toward the radial center of the suction port and is bent toward the compression chamber in the direction away from the reed valve portion, and a second contact portion that extends from the second bent portion and is configured to contact another side of the reed valve portion based on the reed valve portion being opened. The first fixing portion and the second fixing portion may be disposed at the first side and the second side of the longitudinal axis of the reed valve portion, respectively. Thus, the first stopper portion and the second stopper portion may stably support the reed valve portion of the suction valve on both sides.

In some examples, a width of the first bent portion is less than or equal to a width of the first fixing portion, and a width of the second bent portion is less than or equal to a width of the second fixing portion. Accordingly, the first bent portion may suppress occurrence of a bent surface between the first fixing portion and the first bent portion to prevent a damage to a space between the first fixing portion and the first bent portion.

In some examples, a width of the first contact portion is greater than or equal to a width of the first bent portion, and a width of the second contact portion is greater than or equal to a width of the second bent portion. Accordingly, the first contact portion and the second contact portion may be configured to have an area almost corresponding to an area of an opening/closing end of the reed valve portion to stably support the reed valve portion of the suction valve.

In some examples, the first contact portion is disposed closer to the suction port than the first bent portion in a radial direction, and the second contact portion is disposed closer to the suction port than the second bent portion in the radial direction. By doing so, as rigidity of the first contact portion and the second contact portion is decreased, the reed valve portion of the suction valve may be greatly bent and opened, thereby increasing an amount of suctioned refrigerant.

In some implementations, the stopper portion may be a single stopper portion. Thus, the suction valve stopper may be easily machined by simplifying a shape of the stopper portion.

In some examples, the radial center of the suction port is disposed at a position eccentric with respect to a radial center of the compression chamber, where the reed valve portion extends longitudinally from an outside of the suction port toward the radial center of the suction port in a radial direction, and the single stopper portion is disposed at a side corresponding to the position of the suction port with respect to a center line perpendicular to a longitudinal axis of the reed valve portion. By doing so, while only one stopper portion is disposed, rigidity of the stopper portion may be increased to stably support the reed valve portion of the suction valve.

In some examples, the single stopper portion may be disposed at the longitudinal axis of the reed valve portion. By doing so, while only one stopper portion is disposed, the reed valve portion of the suction valve may be symmetrically supported to provide stable support.

In some examples, the single stopper portion may include a fixing portion that extends from the stopper fixing portion and is fixed to the front-end surface of the cylinder, the fixing portion being disposed at a radial outer periphery of the compression chamber, a bent portion that extends from the fixing portion toward the radial center of the suction port and is bent toward the compression chamber in a direction away from the reed valve portion, and a contact portion that extends from the bent portion and is configured to contact one side of the reed valve portion based on the reed valve portion being opened, where a radial center of the contact portion is disposed at a position eccentric toward another side of the reed valve portion with respect to the radial center of the suction port. Accordingly, a space between the suction valve and the suction valve stopper may be sufficiently secured to prevent excessive increase in support force for the suction valve at a beginning of opening.

According to another aspect, a reciprocating compressor includes a piston, a cylinder that accommodates the piston and defines a compression chamber together with the piston inserted in the cylinder, where the piston is configured to reciprocate relative to the cylinder, a valve plate that is coupled to a front-end surface of the cylinder and faces the piston, the valve plate defining a suction port and a discharge port that are configured to fluidly communicate with the compression chamber, a suction valve including (i) a valve fixing portion disposed between the cylinder and the valve plate and coupled to the cylinder and (ii) a reed valve portion configured to open and close the suction port, the reed valve portion having a first end extending from the valve fixing portion and a second end configured to open and close the suction port, and at least one suction valve stopper disposed between the suction valve and the cylinder and configured to limit an opening amount of the suction valve, where the at least one suction valve stopper is fixed to the front-end surface of the cylinder. By doing so, as the stopper fixing portion is excluded from the suction valve stopper, a material cost of the suction valve stopper may be reduced.

Implementations according to this aspect can include one or more of the following features. For example, the stopper fixing portion may include a fixing portion fixed to the front-end surface of the cylinder and disposed at a radial outer periphery of the compression chamber, a bent portion that extends from the fixing portion toward a radial center of the suction port and is bent toward the compression chamber in a direction away from the reed valve portion, and a contact portion that extends from the bent portion and is configured to contact one side of the reed valve portion based on the reed valve portion being opened, where the front-end surface of the cylinder defines a stopper fixing groove that receives the fixing portion. Accordingly, even when the stopper fixing portion is excluded from the suction valve stopper, the fixing portion of the suction valve stopper may be stably fixed between the cylinder and the suction valve.

In some implementations, the fixing portion includes a support protrusion that extends in a direction intersecting a longitudinal axis of the suction valve stopper, and the front-end surface of the cylinder further defines a support protrusion insertion groove that extends from the stopper fixing groove and receives the support protrusion. By doing so, as the support protrusion of the suction valve stopper may be inserted into the support protrusion insertion groove in the cylinder to be radially supported, the stopper portion may be stably fixed to the front-end surface of the cylinder when the piston moves backward.

In some examples, the front-end surface of the cylinder further defines a stopper insertion groove that receives the contact portion. By doing so, the suction valve stopper may be configured as a single stopper portion, but the piston may move forward to the front-end surface of the cylinder to suppress occurrence of dead volume.

In some examples, the suction valve stopper may include a first stopper disposed at a first side of a longitudinal axis of the reed valve portion, and a second stopper disposed at a second side of the longitudinal axis of the reed valve portion. Accordingly, as the first stopper portion and the second stopper portion may symmetrically support the reed valve portion of the suction valve, an opening amount of the suction valve may be stably supported.

In some examples, the at least one suction valve stopper is a single suction valve stopper that is disposed at a longitudinal axis of the reed valve portion. Thus, while only one stopper portion is disposed, rigidity of the stopper portion may be increased, and while only one stopper portion is disposed, the reed valve portion of the suction valve may be symmetrically supported to provide stable support.

### BRIEF DESCRIPTION OF THE DRAWINGS

The above and other aspects, features and other advantages of the present disclosure will be more clearly understood from the following detailed description taken in conjunction with the accompanying drawings.

FIG. 1 is a perspective projection view illustrating an inside of a shell of an example of a reciprocating compressor.

FIG. 2 is a sectional view illustrating an inside of the reciprocating compressor of FIG. 1.

FIG. 3 is an exploded perspective view showing an example of a valve assembly.

FIG. 4 is an exploded perspective view showing an example of a suction valve and a suction valve stopper each shown in FIG. 3.

FIG. 5 is a plan view illustrating an example of a cylinder into which the suction valve and the suction valve stopper each shown in FIG. 4 are assembled.

FIG. 6 is a sectional view taken along line “VIII-VIII” of FIG. 5.

FIG. 7 is a sectional view taken along line “IX-IX” of FIG. 5.

FIG. 8 is a schematic diagram illustrating an example state of contact between the suction valve and the suction valve stopper during high load operation.

FIG. 9 is a schematic diagram illustrating an example state of contact between the suction valve and the suction valve stopper during low load operation.

FIG. 10 is a graph showing an example result of comparing a change in cooling power in each operational range during application of the suction valve stopper with that in the related art.

FIG. 11 is a graph showing a result of comparing an efficiency change in each operational range during application of the suction valve stopper with that in related art.

FIG. 12 is a perspective view illustrating an example of a suction valve stopper.

FIG. 13 is a plan view illustrating an example of a cylinder into a suction valve and the suction valve stopper each shown in FIG. 12 are assembled.

FIG. 14 is a sectional view taken along line “XV-XV” of FIG. 13.

FIG. 15 is a perspective view illustrating an example of a suction valve stopper.

FIG. 16 is a plan view illustrating an example of a cylinder into which a suction valve and the suction valve stopper each shown in FIG. 15 are assembled.

FIGS. 17 and 18 are sectional views taken along line “XVIII-XVIII” of FIG. 16, where FIG. 17 illustrates a suction stroke of a piston, and FIG. 18 illustrates a discharge stroke of the piston.

### DETAILED DESCRIPTION

Description will now be given of a reciprocating compressor according to one or more implementations disclosed herein, with reference to the accompanying drawings.

In some implementations, a compressor includes a suction valve configured to guide refrigerant to a compression chamber and trap the refrigerant, when suctioned into the compression chamber, to compress the trapped refrigerant. Depending on a compression method, the suction valve may be installed together with a discharge valve or separately from the discharge valve. In some implementations, a reciprocating compressor in which a suction valve is installed together with a discharge valve is mainly described. However, the present disclosure is not limited thereto, and may be applied to a compressor having a valve assembly constituted by a suction valve and a discharge valve.

In some implementations, a single suction valve may be included, or a plurality of suction valves may be included independently or included to be connected to each other. In the present disclosure, an example in which a single suction valve is included is mainly described. However, the present disclosure may also be applied a case when a plurality of suction valves are disposed independently or to be connected to each other.

In addition, hereinafter, a side on which a compression chamber is located with reference to a piston is defined as a front side, and an opposite side is defined as a rear side. In association with this, in the valve assembly, a side toward which the suction valve is open is defined as a front side, and a side toward which the suction valve is closed is defined as a rear side.

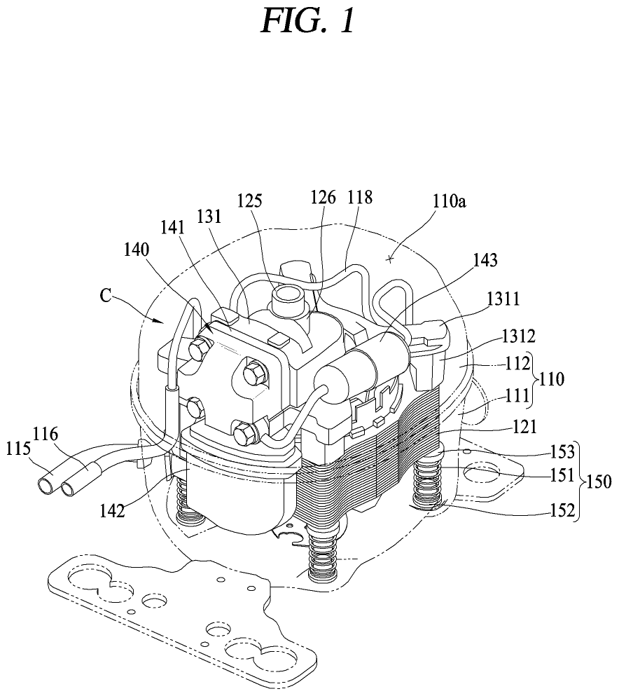

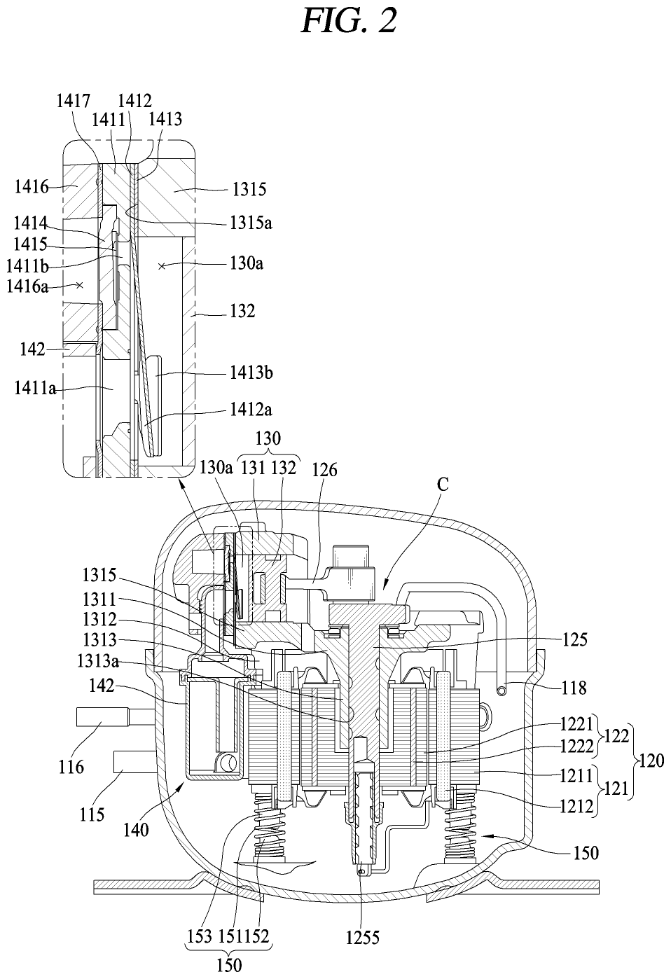

FIG. 1 is a perspective projection view illustrating an inside of a shell of the reciprocating compressor. FIG. 2 is a sectional view illustrating an inside of the reciprocating compressor of FIG. 1.

Referring to FIGS. 1 and 2, the reciprocating compressor includes a shell 110 defining an outer appearance, a motor unit 120 included in an inner space 110a of the shell 110 and configured to provide driving force, a compression unit 130 configured to receive the driving force from the motor unit 120 and compress refrigerant, a suction/discharge unit 140 configured to guide the refrigerant to a compression chamber and discharge the compressed refrigerant, and support portions 150 configured to support a compressor main body C including the motor unit 120 and the compression unit 130 with respect to the shell 110.

In detail, the shell 110 includes a lower shell 111 and an upper shell 112. The lower shell 111 and the upper shell 112 may be combined to each other to define the inner space 110a which is enclosed. The motor unit 120 and the compression unit 130 may be accommodated in the inner space 110a of the shell 110. The shell 110 may be made of an aluminum alloy (hereinafter, abbreviated as aluminum) having a light weight and a high thermal conductivity.

The lower shell 111 may be configured to have an approximately hemispherical shape. A suction pipe 115, a discharge pipe 116, and a process pipe may penetrate and be coupled into the lower shell 111. The suction pipes 115, the discharge pipes 116, and the process pipes may each be coupled into the lower shell 111 using an insert die casting method.

The upper shell 112 may be configured to have an approximately hemispherical shape like the lower shell 111. The upper shell 112 may be coupled to the lower shell 111 on an upper side of the lower shell 111 to define the inner 110a of the shell 110 described above.

In addition, the upper shell 112 and the lower shell 111 may be combined with each other by welding. However, when made of an aluminum material that is difficult to weld, the lower shell 111 and the upper shell 112 may be fastened with bolts.

Referring to FIGS. 1 and 2, the motor unit 120 (e.g., driving motor) may include a stator 121 and a rotor 122. The stator 121 may be elastically supported against the inner space 110a of the shell 110, i.e., a bottom surface of the lower shell 111, and the rotor 122 may rotatably equipped inside the stator 121.

The stator 121 may include a stator core 1211 and a stator coil 1212.

The stator core 1211 is made of a metal material such as an electrical steel sheet, and when a voltage is applied to the motor unit 120 from outside, performs an electromagnetic interaction through electromagnetic force together with the stator coil 1212, which will be described later, and the rotor 122.

The stator core 1211 is configured to have a shape of an approximately rectangular box. For example, an inner circumferential surface of the stator core 1211 may be configured to have a circular shape, and an outer circumferential surface thereof may be configured to have a rectangular shape. The stator core 1211 may be fixed to a lower surface of a main bearing 131 by a stator fastening bolt.

In a state in which the stator core 1211 is spaced apart from an inner surface of the shell 110 in an axial direction and a radial direction, a lower end of the stator core 1211 may be supported by a support spring 151, which will be described later, with respect to a bottom surface of the shell 110. Accordingly, vibration generated during operation may be suppressed from being directly transmitted to the shell 110.

The stator coil 1212 may be wound inside the stator core 1211. As described above, when a voltage is applied from outside, the stator coil 1212 generates electromagnetic force to perform an electromagnetic interaction together with the stator core 1211 and the rotor 122. By doing so, the motor unit 120 generates a driving force for a reciprocating motion of the compression unit 130.

The rotor 122 includes a rotor core 1221 and a magnet 1222.

The rotor core 1221 is made of a metal material such as an electrical steel sheet like the stator core 1211, and may be configured to have an approximately cylindrical shape. A drive shaft 125 may be press-fitted into a center of the rotor core 1221.

The magnet 1222 is made of a permanent magnet and may be inserted to be coupled at equal intervals along a circumferential direction of the rotor core 1221. When voltage is applied, the rotor 122 rotates through electromagnetic interaction with the stator core 1211 and the stator coil 1212. Accordingly, the drive shaft 125 rotates together with the rotor 122 to transmit rotational force of the motor unit 120 to the compression unit 130 through a connecting rod 126.

Referring to FIGS. 1 to 2, the compression unit 130 may include the main bearing 131 and a piston 132. The main bearing 131 is elastically supported by the shell 110, and the piston 132 is coupled to the drive shaft 125 by the connecting rod 126 to move relative to the main bearing 131.

The main bearing 131 may be disposed on one axial side, e.g., an upper side of the motor unit 120. The main bearing 131 is fastened to the stator 121 with the stator fastening bolt, and may be elastically supported with respect to the lower shell 111 together with the stator 121 of the motor unit 120.

The main bearing 131 may include a frame portion 1311, a fixing protrusion 1312 coupled to the stator 121 of the motor unit 120, a bearing portion 1313 supporting the drive shaft 125, and a cylinder portion (cylinder) 1315 constituting the compression chamber 130a.

The frame portion 1311 may be configured to have a flat plate shape extending in a transverse direction or a radiating plate shape obtained by performing a slimming processing on some edges excluding corners.

The fixing protrusion 1312 may be disposed at an edge of the frame portion 1311. For example, the fixing protrusion 1312 may be disposed to protrude downwardly from the edge of the frame portion 1311 toward the motor unit 120.

The bearing portion 1313 may be disposed to extend from a center portion of the frame portion 1311 to both sides in an axial direction. A bearing hole 1313a is disposed through the bearing portion 1313 in an axial direction to have the drive shaft 125 penetrating therethrough, and a bush bearing may be inserted and coupled into an inner circumferential surface of the bearing hole 1313a.

The drive shaft 125 may be supported in an axial direction at an upper end of the bearing portion 1313, and the drive shaft 125 may be supported on an inner circumferential surface of the bearing portion 1313 in a radial direction. Accordingly, the drive shaft 125 may be supported by the main bearing 131 in axial and radial directions.

The cylinder portion (hereinafter abbreviated as a cylinder) 1315 may be disposed eccentrically in a radial direction at one side edge of the frame portion 1311. The cylinder 1315 may be penetrated in a radial direction such that the piston 132 connected to the connecting rod 126 is inserted into an inner opening end and a valve assembly 141 constituting the suction/discharge unit 140, which will be described later, is equipped with an outer opening end. The cylinder 1315 will be described again together with a valve plate 1411, a suction valve 1412, and a suction valve stopper 1413.

A side (rear side) of the piston 132 facing the connecting rod 126 may be open, whereas an opposite side (front side) facing away from the connecting rod 126 may have a closed and flat shape. Accordingly, the connecting rod 126 is inserted and rotatably coupled into a rear side of the piston 132, and a front side of the piston 132 defines the compression chamber 130a inside the cylinder 1315 together with the valve assembly 141, which will be described later.

Referring to FIGS. 1 and 2, the suction/discharge unit 140 may include the valve assembly 141, a suction muffler 142, and a discharge muffler 143. The valve assembly 141 and the suction muffler 142 may be sequentially coupled from an open end of the cylinder 1315.

The valve assembly 141 may include the valve plate 1411, the suction valve 1412, the suction valve stopper 1413, a discharge valve 1414, a discharge valve stopper 1415, a discharge cover 1416, and a gasket 1417. In some examples, the valve assembly 141 may further include a gasket between respective members in addition to the gasket 1417 described above.

The valve plate 1411 may be configured to have an approximately rectangular plate shape and equipped to cover a front-end surface of the main bearing 131, i.e., an opening surface on one side of the compression chamber 130a. For example, fastening holes (no reference numeral) may be disposed at corners of the valve plate 1411, respectively, to be bolted to fastening grooves (no reference numeral) disposed in the front-end surface of the main bearing 131.

The valve plate 1411 may be configured to have both side surfaces with an approximately flat shape, and a central portion in which one suction port 1411a and one discharge port 1411b are disposed. However, in some cases, a plurality of suction ports 1411a and/or discharge ports 1411b may be disposed. In some implementations, as described above, an example in which one suction port 1411a and one discharge port 1411b are disposed and the suction port 1411a is disposed in a position eccentric from a radial center Oc of the compression chamber 130a which is to be described later. The valve plate 1411 will be described later together with the cylinder 1315, the suction valve 1412, and the suction valve stopper 1413.

In some examples, the suction valve 1412 is configured as a rectangular plate made of a thin steel plate having elasticity, and may be placed on a side of the valve plate 1411 facing the piston 132, i.e., on a rear side surface. For example, the suction valve 1412 may include a valve fixing portion 1412a and a reed valve portion 1412b, wherein the valve fixing portion 1412a constitutes an edge and is fixed between the cylinder 1315 and the valve plate 1411, and the reed valve portion 1412b may be configured to have a cantilever shape obtained by performing cutting on a center portion of the valve fixing portion 1412a to thereby open/close the suction port 1411a. Accordingly, the suction valve 1412 may be opened or closed as an opening/closing end 1412b2 of the reed valve portion 1412b, which is to be described later, is bent in a direction toward the piston 132 with reference to a fixed end 1412b1. The suction valve 1412 is to be described later together with the cylinder 1315, the valve plate 1411, and the suction valve stopper 1413.

Like the suction valve 1412, the suction valve stopper 1413 may be configured as a rectangular plate made of a thin steel plate having elasticity, and may be placed on one side surface of the suction valve 1412, that is, on a rear side surface facing the piston 132. Stopper portions 1418a and 1418b, which will be described later, may be disposed in the suction valve stopper 1413 to have a cantilever shape by performing cutting on a stopper fixing portion 1413a which will be also described later. Accordingly, the suction valve stopper 1413 has a stopper portion 1413b, which will be described later, disposed on a side surface in an opening direction with respect to the reed valve portion 1412b of the suction valve 1412 to elastically limit an opening amount of the reed valve portion 1412b. The suction valve stopper 1413 will be described later together with the cylinder 1315, the valve plate 1411, and the suction valve 1412.

The discharge valve 1414 may be configured as a long plate made of a thin steel plate and placed on a front side surface of the valve plate 1411. Accordingly, the discharge valve 1414 may open or close the discharge port 1411b by being bent in a direction away from the piston 132.

The discharge valve stopper 1415 may be configured as a rigid body and disposed between the discharge valve 1414 and the discharge cover 1416. One end of the discharge valve stopper 1415 may be in close contact with the discharge valve 1414, and the other end thereof may be spaced apart from the discharge valve 1414 by a preset distance. Accordingly, the discharge valve stopper 1415 may press and fix the discharge valve 1414 onto the valve plate 1411 and, simultaneously, limit an opening amount of the discharge valve 1414.

The discharge cover 1416 may be fastened to a front-end surface of the main bearing 131 to have the valve plate 1411, the suction valve 1412, and the suction valve stopper 1413 interposed therebetween to thereby finally cover the compression chamber 130a. In other words, the discharge cover 1416 may also be referred to as a cylinder cover. Accordingly, as the discharge valve 1414 is opened, refrigerant discharged from the compression chamber 130a through the discharge port 1411b may move to the discharge muffler 143 via the discharge cover 1416.

Referring to FIGS. 1 to 2, the suction muffler 142 may be fixed by the valve assembly 141 to communicate with the suction port 1411a of the valve plate 1411. A suction space portion (no reference numeral) may be disposed in the suction muffler 142, and an inlet of the suction space portion may communicate directly or indirectly with the suction pipe 115, and an outlet of the suction space portion may directly communicate with a suction side of the valve assembly 141. Accordingly, the suction muffler 142 may transmit refrigerant suctioned through the suction pipe 115 to the compression chamber 130a of the cylinder 1315.

Referring to FIGS. 1 and 2, the discharge muffler 143 may be equipped to be separate from the main bearing 131. A discharge space portion (no reference numeral) may be disposed in the discharge muffler 143. An inlet of the discharge space portion may be connected to a discharge side of the valve assembly 141 by a loop pipe 118. An outlet of the discharge space portion may be directly connected to the discharge pipe 116 by the loop pipe 118. Accordingly, the discharge muffler 143 may attenuate a pressure pulsation of refrigerant discharged from the compression chamber 130a, and discharge the refrigerant to outside of the compressor through the discharge pipe 116.

Referring to FIGS. 1 and 2, the support portions 150 support a space between a lower surface of the motor unit 120 and a bottom surface of the lower shell 111 facing the lower surface of the motor unit 120. The support portions 150 generally support four corners of the motor unit 120 against the shell 110. For example, the support portions 150 may each include the support spring 151, and a first spring cap 152 and a second spring cap 153 both supporting a lower end of the support spring 151.

The support spring 151 is made of a compression coil spring. The first spring cap 152 is fixed to the bottom surface of the lower shell 111 to support the lower end of the support spring 151. The second spring cap 153 is fixed to a lower end of the motor unit 120 to support an upper end of the support spring 151. Accordingly, each support spring 151 is supported by each first spring cap 152 and each second spring cap 153 to elastically support the compressor main body C with respect to the shell 110.

In the drawings, an undescribed reference numeral 1255 denotes an oil feeder.

The reciprocating compressor operates as described below.

That is, when power is applied to the motor unit 120, the rotor 122 rotates. When the rotor 122 rotates, the drive shaft 125 coupled to the rotor 122 rotates to transmit rotational force to the piston 132 through the connecting rod 126. The piston 132 performs a reciprocating motion in a back-and-forth direction by the connecting rod 126 with respect to the cylinder 1315.

For example, when the piston 132 moves backward (suction stroke) with respect to the cylinder 1315, volume of the compression chamber 130a increases. When the volume of the compression chamber 130a increases, refrigerant filled in the suction muffler 142 passes through the suction valve 1412 of the valve assembly 141 to be suctioned into the compression chamber 130a of the cylinder 1315.

In some examples, when the piston 132 moves forwards (discharge stroke) with respect to the cylinder 1315, volume of the compression chamber 130a decreases. When the volume of the compression chamber 130a decreases, refrigerant filled in the compression chamber 130a is compressed, passes through the discharge valve 1414 of the valve assembly 141, and is discharged into the discharge chamber 1416a of the discharge cover 1416. The discharged refrigerant flows into the discharge space portion of the discharge muffler 143 through the loop pipe 118, and is discharged back through the loop pipe 118 and the discharge pipe 116 as a refrigeration cycle. This series of process is repeatedly performed.

In some implementations, the suction valve 1412 is configured to include the reed valve portion 1412b in which, with reference to one end constituting the fixed end 1412b1, another end constituting the opening/closing end 1412b2 of the reed valve portion 1412b of the suction valve 1412 rotates according to a pressure change in the compression chamber 130a due to the reciprocating motion of the piston 132, i.e., a difference between a pressure of the compression chamber 130a and an internal pressure of the suction muffler 142, thereby opening or closing the suction port 1411a.

For example, when the piston 132 moves backward (suction stroke), an internal pressure of the suction muffler 142 becomes higher than a pressure of the compression chamber 130a. In some examples, with reference to the one end constituting the fixed end 1412b1, the another end constituting the opening/closing end 1412b2 of the reed valve portion 1412b of the suction valve 1412 rotates. Thus, the suction port 1411a of the valve plate 1411 is opened.

At this time, when the compressor performs high load operation (e.g., high pressure and/or high-speed operation), a reciprocating speed of the piston 132 increases to 80 Hz or higher, thereby increasing an opening amount of the suction valve 1412. In other words, during high load operation, the reed valve portion 1412b of the suction valve 1412 may be excessively leaned back, thereby increasing a fatigue strength at the one end constituting the fixed end 1412b1. Since this may cause a damage to the suction valve 1412, there is a limit in diversifying an operating range of the compressor or implementing high-efficiency operation.

In consideration of this, when a stopper portion and/or a stopper member configured as a rigid body is disclosed between the cylinder 1315 and the suction valve 1412, an opening amount of the suction valve 1412 cannot be sufficiently secured during high load operation. Thus, cooling power and/or efficiency may deteriorate.

Accordingly, in some implementations, a suction valve stopper configured to elastically limit an opening amount of the suction valve may be disposed on one side of the suction valve, that is, on one side of the suction valve facing the cylinder.

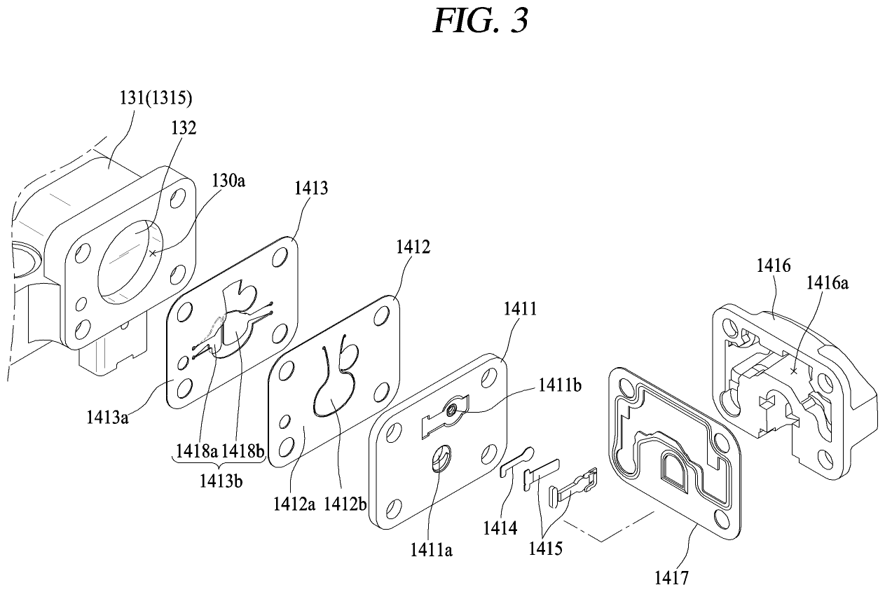

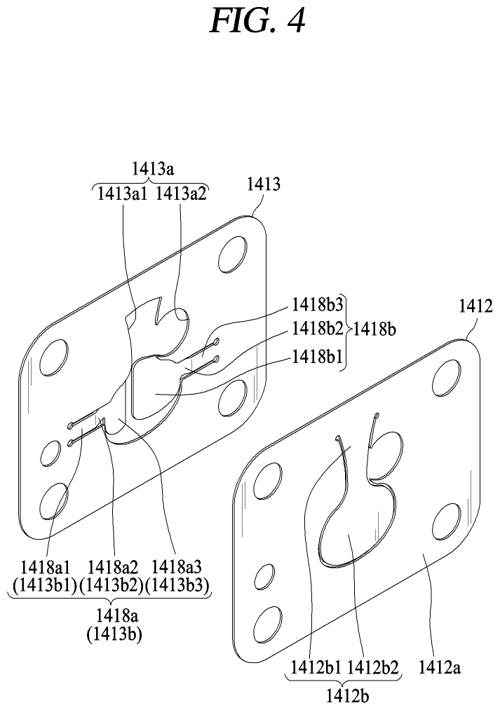

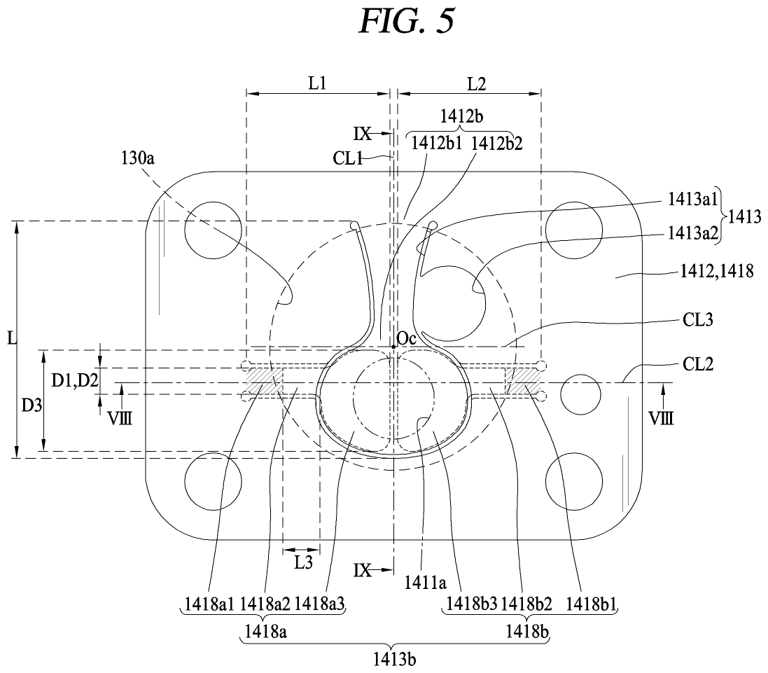

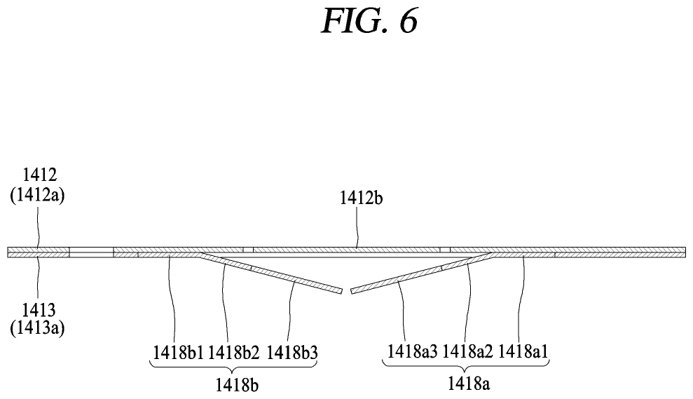

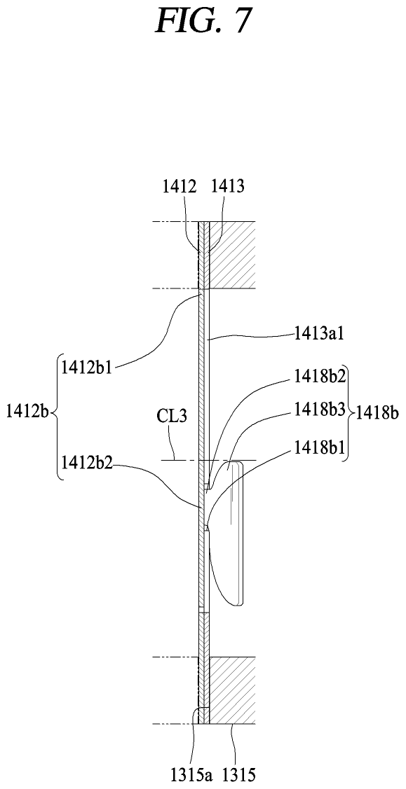

FIG. 3 is an exploded perspective view of the valve assembly. FIG. 4 is an exploded perspective view of the suction valve and the suction valve stopper each shown in FIG. 3. FIG. 5 is a plan view illustrating the cylinder into which the suction valve and the suction valve stopper each shown in FIG. 4 are assembled. FIG. 6 is a sectional view taken along line “VIII-VIII” of FIG. 5. FIG. 7 is a sectional view taken along line “IX-IX” of FIG. 5.

Referring to FIGS. 3 to 7, the suction valve stopper 1413 configured to limit an opening amount of the suction valve 1412 may be disposed between a front-end surface 1315a of the cylinder 1315 and a rear surface (no reference numeral) of the suction valve 1412. Accordingly, excessive opening of the reed valve portion 1412b of the suction valve 1412 during backward movement (discharge stroke) of the piston 132 may be limited, and thus, a damage to the suction valve 1412 may be prevented. By doing so, even when the reciprocating compressor is small, operation at a high load of 80 Hz or greater may be performed.

For example, the suction valve stopper 1413 may be made of an elastic member. In other words, the suction valve stopper 1413 may be configured as a thin steel plate having elasticity like the suction valve 1412 and have a material and/or a thickness having rigidity equal to or greater than that of the suction valve 1412. Accordingly, when the suction valve 1412 is opened or closed, the suction valve stopper 1413 may elastically limit an opening/closing operation of the suction valve 1412.

In some implementations, a surface of the suction valve stopper 1413 may be coated with a sealing material such as rubber. Accordingly, sealing between the cylinder 1315 and the suction valve stopper 1413 and/or between the suction valve stopper 1413 and the suction valve 1412 may be effectively performed without having to apply a separate gasket therebetween.

Additionally, at least one stopper portion 1413b may be disposed on a portion of the suction valve stopper 1413 facing the reed valve portion 1412b of the suction valve 1412. In other words, the suction valve stopper 1413 may include at least one stopper portion 1413b extending from the stopper fixing portion 1413a, which will be described later, toward a radial center of the suction port 1411a, and the at least one stopper portion 1413b may be disposed to at least partially overlap the reed valve portion 1412b in a reciprocating direction of the piston 132. Accordingly, when the reed valve portion 1412b of the suction valve 1412 is opened, the at least one stopper portion 1413b may be brought into contact with the reed valve portion 1412b to limit an opening amount of the suction valve 1412.

In this case, the stopper portion 1413b may be configured to have a flat shape like a state in which the suction valve 1412 is closed, but may also be disposed to be bent to be spaced apart from the reed valve portion 1412b by a preset distance. The present disclosure illustrates an example in which the stopper portion 1413b is bent. Accordingly, an opening amount of the suction valve 1412 is not limited or is passively limited in low load operation (low pressure and/or low speed operation), whereas an opening amount of the suction valve 1412 is actively limited in high load operation to prevent the reed valve portion 1412b of the suction valve 1412 from excessively being bent.

For example, the stopper portion 1413b may be bent in a middle, i.e., bent to be inclined to be increasingly away from the reed valve portion 1412b in a direction toward the opening/closing end 1412b2 of the reed valve portion 1412b, or bent to have a step portion in a middle to become away from the reed valve portion 1412b. In some implementations, an example in which the stopper portion 1413b is bent to be inclined is illustrated.

In detail, referring to FIGS. 3 and 4, the suction valve stopper 1413 may include the stopper fixing portion 1413a and a plurality of stopper portions 1418a and 1418b. The stopper fixing portion 1413a is a portion fixed to the front-end surface 1315a of the cylinder 1315 together with the valve fixing portion 1412a of the suction valve 1412, and the plurality of stopper portions 1418a and 1418b are portions in contact with the reed valve portion 1412b of the suction valve 1412 to directly limit an opening amount of the reed valve portion 1412b.

The stopper fixing portion 1413a may be configured as a rectangular plate body having a same sectional area as that of the valve fixing portion 1412a of the suction valve 1412. Accordingly, the suction valve stopper 1413 may be fastened to the front-end surface 1315a of the cylinder 1315 by a fastening member (no reference numeral) configured to fasten the suction valve 1412 to the cylinder 1315.

A valve accommodating portion 1413a1 may be disposed through a center portion of the stopper fixing portion 1413a, and a discharge through hole 1413a2 may be disposed at one side of the valve accommodating portion 1413a1. The valve accommodating portion 1413a1 and the discharge through hole 1413a2 may be disposed separately from each other, or may be disposed to be connected to each other. In the present disclosure, an example in which the valve accommodating portion 1413a1 and the discharge through hole 1413a2 are connected to each other is illustrated. Accordingly, a space between the valve accommodating portion 1413a1 and the discharge through hole 1413a2 may be removed to have a large area of the valve accommodating portion 1413a1 as possible.

Additionally, the valve accommodating portion 1413a1 may be configured to have a shape identical to or almost identical to a shape of the reed valve portion 1412b of the suction valve 1412. In other words, the valve accommodating portion 1413a1 may be configured to be narrow at one end away from the suction port 1411a of the valve plate 1411 and comparatively wide at another end facing the suction port 1411a. Accordingly, the reed valve portion 1412b of the suction valve 1412 may be opened or closed smoothly, and at the same time, a space between the reed valve portion 1412b of the suction valve 1412 and the valve accommodating portion 1413a1 may be minimized to reduce dead volume.

Referring to FIGS. 4 and 5, a plurality of stopper portions 1413b may include the plurality of stopper portions 1418a and 1418b, i.e., a first stopper portions 1418a and a second stopper portion 1418b. The first stopper portion 1418a is disposed on one side with reference to a first center line CL1 extending along a longitudinal direction (hereinafter, a first center line direction) of the reed valve portion 1412b, and the second stopper portion 1418b may be disposed on another side with reference to the first center line CL1. In other words, the first stopper portion 1418a and the second stopper portion 1418b may be disposed on both sides, respectively, to be spaced apart from each other with reference to the first center line CL1. That is, the first center line CL1 defines a longitudinal axis of the reed valve portion 1412b. The reed valve portion 1412b may have length L in a longitudinal direction extending along the first center line CL1.

In this case, the first stopper portion 1418a and the second stopper portion 1418b may be disposed in a direction intersecting an opening/closing direction of the reed valve portion 1412b of the suction valve 1412, i.e., in a direction intersecting the first center line CL1. For example, the first stopper portion 1418a and the second stopper portion 1418b may be disposed to face each other along the second center line CL2 extending in a direction (hereinafter referred to as a second center line direction) perpendicular to the first center line CL1. Accordingly, proper rigidity of the first stopper portion 1418a and the second stopper portion 1418b may be maintained.

For example, when the first stopper portion 1418a and the second stopper portion 1418b are disposed to be inclined in a direction toward the fixed end 1412b1 of the reed valve portion 1412b, as lengths the first stopper portion 1418a and the second stopper portion 1418b are small, rigidity of both the first and second stopper portions 1418a and 1418b may increase excessively. In some examples, when the first stopper portion 1418a and the second stopper portion 1418b are disposed to be inclined in a direction facing away from the fixed end 1412b1 of the reed valve portion 1412b, the first stopper portion 1418a and the second stopper portion 1418b may not only have a great length, but also be bent in a direction almost identical to a direction of the reed valve portion 1412b. Thus, rigidity of both the first and second stopper portions 1418a and 1418b may be reduced.

Accordingly, in some implementations, the first stopper portion 1418a and the second stopper portion 1418b are disposed to be perpendicular to the first center line CL1. Thus, the first stopper portion 1418a and the second stopper portion 1418b may stably support the reed valve portion 1412b of the suction valve 1412 on both sides.

In some implementations, the first stopper portion 1418a and the second stopper portion 1418b may be disposed at an angle greater or smaller than a right angle with respect to the first center line CL1. For example, the first stopper portion 1418a and the second stopper portion 1418b may be disposed to be inclined at one end of the reed valve portion 1412b constituting the fixed end 1412b1 toward the suction port 1411a. In this case, as a length of the first stopper portion 1418a and a length the second stopper portion 1418b are great, rigidity of both the first and second stopper portions 1418a and 1418b decreases. Thus, an opening amount of the suction valve 1412 may further increase. In some examples, the first stopper portion 1418a and the second stopper portion 1418b may be disposed to be inclined at another end of the reed valve portion 1412b constituting the opening/closing end 1412b2 toward the suction port 1411a. In this case, as a length of the first stopper portion 1418a and a length of the second stopper portion 1418b are small, rigidity of both the first and second stopper portions 1418a and 1418b increases. Thus, an opening amount of the suction valve 1412 may be actively limited.

In addition, the first stopper portion 1418a and the second stopper portion 1418b may be disposed symmetrically to each other with reference to the first center line CL1. Thus, not only the first stopper portion 1418a and the second stopper portion 1418b may be easily manufactured, but also the first stopper portion 1418a and the second stopper portion 1418b may symmetrically support the reed valve portion 1412b of the suction valve 1412. Accordingly, an opening amount of the suction valve 1412 may be stably supported. Hereinafter, a description will be provided mainly about the first stopper portion 1418a, and the description about the first stopper portion 1418a will replace a description about the second stopper portion 1418b.

Referring to FIGS. 4 to 6, the first stopper portion 1418a may be disposed eccentrically from the radial center Oc of the compression chamber 130a toward the suction port 1411a. In other words, the first stopper portion 1418a may be disposed to be eccentrically toward the suction port 1411a with respect to a third center line CL3 perpendicular to the first center line CL1 and passing through the radial center Oc of the compression chamber 130a.

For example, as the suction port 1411a of the valve plate 1411 is disposed eccentrically with respect to the third center line CL3, another end of the reed valve portion 1412b of the suction valve 1412 constituting the opening/closing end 1412b2 may be disposed eccentrically toward the suction port 1411a with respect to the third center line CL3, and the first stopper portion 1418a configured to limit an opening amount of the reed valve portion 1412b of the suction valve 1412 may be also disposed in a position eccentric toward the suction port 1411a with respect to the third center line CL3. Accordingly, a length L1 of the first stopper portion 1418a may be configured to be smaller than a length L2 of the reed valve portion 1412b of the suction valve 1412. By doing so, rigidity of the first stopper portion 1418a may become greater than that of the reed valve portion 1412b of the suction valve 1412. Thus, the first stopper portion 1418a may stably limit an opening amount of the reed valve portion 1412b of the suction valve 1412.

In detail, referring to FIGS. 4 to 7, the first stopper portion 1418a may include a first fixing portion 1418a1, a first bent portion 1418a2, and a first contact portion 1418a3. As described above, the first fixing portion 1418a1 extends from one side of the stopper fixing portion 1413a to constitute one end of the first stopper portion 1418a, the first bent portion 1418a2 is disposed between the first fixing portion 1418a1 and the first contact portion 1418a3, and the first contact portion 1418a3 extends from the first bent portion 1418a2 to constitute another end of the first stopper portion 1418a. Accordingly, the first fixing portion 1418a1, the first bent portion 1418a2, and the first contact portion 1418a3 may be constituted as one single body.

The first fixing portion 1418a1 may extend along the second center line CL2 from one side of the stopper fixing portion 1413a, and be fixed to the front-end surface 1315a of the cylinder 1315 in a radial outer periphery of the compression chamber 130a. In other words, the first fixing portion 1418a1 may be obtained by performing cutting at the stopper fixing portion 1413a along a direction perpendicular to a longitudinal direction of the reed valve portion 1412b, and fixed at the front-end surface 1315a of the cylinder 1315 by being pressed together with the suction valve 1412 by the valve plate 1411. Accordingly, the first fixing portion 1418a1 may be disposed outside the valve accommodating portion 1413a1 located at a center portion of the stopper fixing portion 1413a to prevent interference with the reed valve portion 1412b of the suction valve 1412 when the suction valve 1412 is opened or closed.

The first bent portion 1418a2 may extend from an inner end (an end toward a center portion) of the first fixing portion 1418a1 to be located outside the reed valve portion 1412b inside the compression chamber 130a. In other words, the first bent portion 1418a2 may be disposed to be located between an inner circumferential surface of the compression chamber 130a and an outer circumferential surface of the reed valve portion 1412b. Accordingly, an edge of the suction valve 1412 in contact with the front-end surface 1315a of the cylinder 1315 may be suppressed from being lifted by the first bent portion 1418a2, and the reed valve portion 1412b of the suction valve 1412 may be suppressed from being in contact with the first bent portion 1418a2 to thereby stably limit an opening amount of the suction valve 1412.

Additionally, the first bent portion 1418a2 may be disposed to be bent on one side surface of the suction valve 1412 in a direction away from the suction valve 1412. For example, the first bent portion 1418a2 may be disposed to be bent such that the first contact portion 1418a3 has an inclination of approximately 15° to 60° with respect to the first fixing portion 1418a1. Accordingly, the first contact portion 1418a3, which will be described later, may have a height difference of approximately 0.5 to 5 mm from the reed valve portion 1412b.

For example, a width D2 of the first bent portion 1418a2 may be configured to be identical to a width D1 of the first fixing portion 1418a1. Accordingly, the first bent portion 1418a2 may suppress occurrence of a bent surface between the first fixing portion 1418a1 and the first bent portion 1418a2 to prevent a damage between the first fixing portion 1418a1 and the first bent portion 1418a2.

In some implementations, the width D2 of the first bent portion 1418a2 may be configured to be smaller or greater than the width D1 of the first fixing portion 1418a1. For example, when the width D2 of the first bent portion 1418a2 is configured to be smaller than the width D1 of the first fixing portion 1418a1, a fixing area of the first fixing portion 1418a1 may be secured, and rigidity of the first stopper portion 1418a may be reduced to thereby expand an opening amount of the suction valve 1412. In some examples, when the width D2 of the first bent portion 1418a2 is configured to be smaller than the width D1 of the first fixing portion 1418a1, reliability of the first stopper portion 1418a may be enhanced. However, when the width D1 of the first fixing portion 1418a1 is configured to be different from the width D2 of the first bent portion 1418a2, a space between the first fixing portion 1418a1 and the first bent portion 1418a2 may be configured to be inclined or bent by performing cutting to thereby improve reliability.

The first contact portion 1418a3 may extend from the first bent portion 1418a2, and as described above, may be disposed to be inclined at a preset angle from the suction valve 1412 (e.g., approximately 15° to 60° with respect to the first fixing portion). Accordingly, the first contact portion 1418a3 may not be in contact with or may be in weak contact with the reed valve portion 1412b of the suction valve 1412 when the reed valve portion 1412b is closed or low load operation is performed, whereas the first contact portion 1418a3 may be in strong contact with the reed valve portion 1412b to be bent together with the reed valve portion 1412b when the reed valve portion 1412b is opened or high load operation is performed.

The first contact portion 1418a3 may be configured to be larger than the first bent portion 1418a2 (and/or the first fixing portion). For example, the first contact portion 1418a3 may be configured in a semicircular shape to be equal to or smaller than another end of the reed valve portion 1412b constituting the opening/closing end 1412b2 of the suction valve 1412. In other words, a width D3 of the first contact portion 1418a3 may be configured to be greater than the width D2 of the first bent portion 1418a2 (and/or the first fixing portion) and the first contact portion 1418a3 may have approximately half an area of the opening/closing ends 1412b2 of the reed valve portion 1412b. Accordingly, the first contact portion 1418a3, together with the second contact portion 1418b3, which will be described later, may be configured to have an area almost corresponding to an area of the opening/closing end 1412b2 of the reed valve portion 1412b to stably support the reed valve portion 1412b of the suction valve 1412.

The first contact portion 1418a3 may be disposed eccentrically toward the suction port 1411a with respect to the second center line CL2 connecting the first fixing portion 1418a1 (or the first bent portion) to a second fixing portion 1418b1 (or a second bent portion) which is to be described later. In other words, the first contact portion 1418a3 may be connected to the first bent portion 1418a2 in a position eccentrically toward the radial center Oc of the compression chamber 130a. Accordingly, since the first contact portion 1418a3 may extend longitudinally toward the suction port 1411a with respect to the first bent portion 1418a2, thereby reducing rigidity of the first contact portion 1418a3. By doing so, during high load operation, the reed valve portion 1412b of the suction valve 1412 may be greatly bent and opened, thereby increasing an amount of refrigerant to be suctioned. For example, the reed valve portion 1412b may be bent inward relative to the suction valve stopper 1413 toward the suction port 1411a during the high load operation.

Referring to FIGS. 4 to 6, the second stopper portion 1418b may include the second fixing portion 1418b1, a second bent portion 1418b2, and the second contact portion 1418b3. As described above, the second fixing portion 1418b1 extends from another side of the stopper fixing portion 1413a to constitute one end of the second stopper portion 1418b, the second bent portion 1418b2 is disposed between the second fixing portion 1418b1 and the second contact portion 1418b3, and the second contact portion 1418b3 extends from the second bent portion 1418b2 to constitute another end of the second stopper portion 1418b. Accordingly, the second fixing portion 1418b1, the second bent portion 1418b2, and the second contact portion 1418b3 may be configured as one single body.

The second fixing portion 1418bl may be disposed on a side opposite to the first fixing portion 1418a1 with reference to the first center line CL1. The second bent portion 1418b2 may be disposed on a side opposite to the first bent portion 1418a2 with reference to the first center line CL1. The second contact portion 1418b3 may be disposed on a side opposite to the first contact portion 1418a3 with reference to the first center line CL1. In other words, with reference to the first center line CL1, the second fixing portion 1418b1 may be disposed to be symmetrical to the first fixing portion 1418a1, the second bent portion 1418b2 may be disposed to be symmetrical to the first bent portion 1418a2, and the second contact portion 1418b3 may be disposed to be symmetrical to the first contact portions 1418a3. Accordingly, a description about the second fixing portion 1418b1 will be replaced by the description about the first fixing portion 1418a1, a description about the second bent portion 1418b2 will be replaced by the description about the first bent portion 1418a2, and a description about the second contact portion 1418b3 will be replaced by the description about the first contact portion 1418a3.

As described above, since the suction valve stopper 1413 having elastic force is disposed between the cylinder 1315 and the suction valve 1412, an opening amount of the suction valve 1412 may be properly limited during high load operation. Accordingly, the reed valve portion 1412b of the suction valve 1412 may be prevented from being excessively bent during suction in high load operation may be suppressed, thereby preventing a valve damage in advance. Also, as the suction valve stopper 1413 is elastically bent along the suction valve 1412, an opening amount of the suction valve 1412 may be sufficiently secured to increase cooling power.

In addition, since the suction valve stopper 1413 is disposed to be bent to be apart from the reed valve portion 1412b of the suction valve 1412 by a preset distance, an opening operation of the suction valve 1412 during initial opening of the suction valve may not be limited when the suction valve 1412 is initially opened. Accordingly, the reed valve portion 1412b of the suction valve 1412 may be opened quickly during high load operation, and the reed valve portion 1412b of the suction valve 1412 may be also opened smoothly even during low load operation. Thus, a proper opening amount of the suction valve 1412 may be secured. By doing so, not only operation may be performed in various operating ranges, but also energy efficiency in respective operating ranges may be improved.

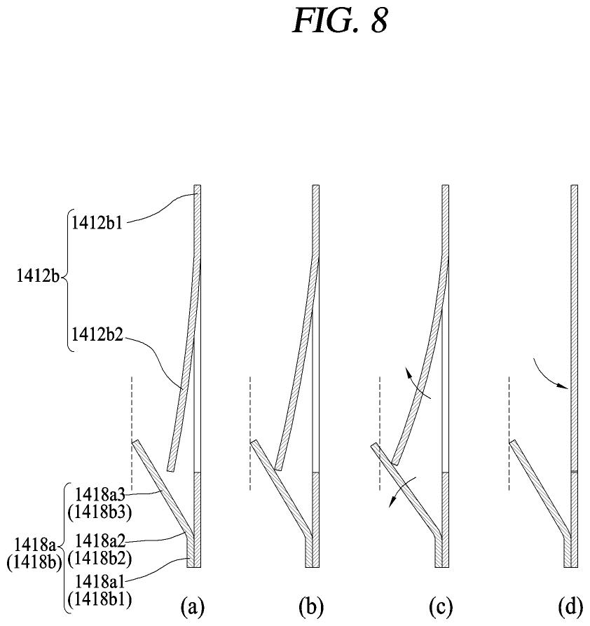

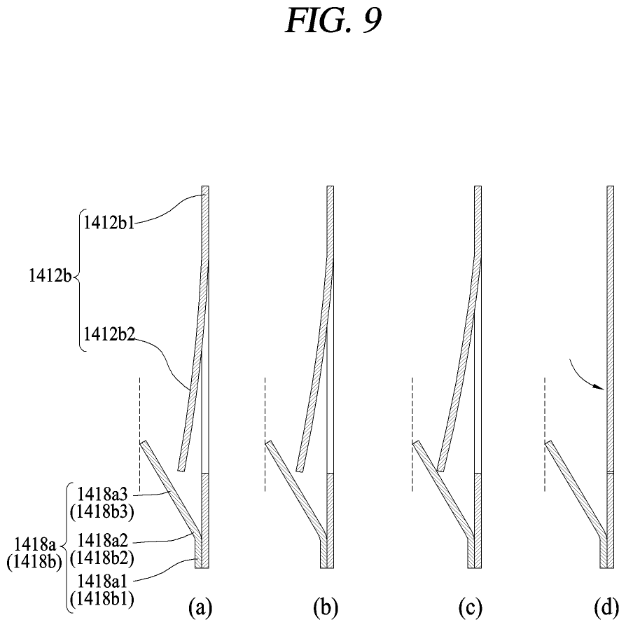

FIG. 8 is a schematic diagram illustrating a state of contact between the suction valve and the suction valve stopper during high load operation. FIG. 9 is a schematic diagram illustrating a state of contact between the suction valve and the suction valve stopper during low load operation.

Referring to FIG. 8, when the reciprocating compressor performs high load operation, the piston 132 performs a reciprocating motion at high speed. Accordingly, the reed valve portion 1412b of the suction valve 1412 is greatly bent to open or close the suction port 1411a.

For example, in stage (a) when the piston 132 begins to move backward and the front-end surface 132a of the piston 132 is slightly away from a top dead center, the reed valve portion 1412b of the suction valve 1412 is slightly bent. For instance, when the reed valve portion 1412b of the suction valve 1412 is bent with a first curvature, as the first contact portion 1418a3 and the second contact portion 1418b3 each included the suction valve stopper 1413 are spaced apart from the suction valve 1412 by a preset distance, the reed valve portion 1412b of the suction valve 1412 may not be in contact with the first contact portion 1418a3 and the second contact portion 1418b3 of the suction valve stopper 1413. Accordingly, at the beginning of the backward movement of the piston 132, the reed valve portion 1412b of the suction valve 1412 is quickly opened to quickly suction refrigerant into the compression chamber 130a.

In some examples, in stage (b) in which the piston 132 moves further backward and the front-end surface 132a of the piston 132 becomes further away from the top dead center, the reed valve portion 1412b of the suction valve 1412 is further bent with a second curvature greater than the first curvature. In some examples, as the reed valve portion 1412b of the suction valve 1412 comes into contact with the first contact portion 1418a3 and the second contact portion 1418b3 each included in the suction valve stopper 1413, an opening operation begins to be limited. However, even in this case, as the first stopper portion 1418a and the second stopper portion 1418b of the suction valve stopper 1413 have elastic force, an opening operation of the reed valve portion 1412b of the suction valve 1412 is not forcibly limited. Accordingly, before the piston 132 moves to a bottom dead center, the reed valve portion 1412b of the suction valve 1412 is continuously opened so that refrigerant may be smoothly suctioned into the compression chamber 130a.

In some examples, as the piston 132 moves further backward, the reed valve portion 1412b of the suction valve 1412 is bent further greatly with a third curvature greater than the second curvature until stage (c) in which the front-end surface 132a of the piston 132 reaches the bottom dead center. In some examples, while being in a contact with the first contact portion 1418a3 and the second contact portion 1418b3 of the suction valve stopper 1413, the reed valve portion 1412b of the suction valve 1412 is strongly subjected to a maximum elastic force of the first stopper portion 1418a and the second stopper portion 1418b both included in the suction valve stopper 1413. In some examples, an opening operation of the reed valve portion 1412b of the suction valve 1412 is limited while being in a contact with the first contact portion 1418a3 and the second contact portion 1418b3 of the suction valve stopper 1413. Thus, the reed valve portion 1412b of the suction valve 1412 is not further bent. Accordingly, even when the reed valve portion 1412b of the suction valve 1412 is greatly bent during high load operation, the reed valve portion 1412b of the suction valve 1412 may be prevented from being damaged.

In some examples, when the piston 132 moves forwards in an opposite direction (discharge stroke), the reed valve portion 1412b of the suction valve 1412 rotates in the opposite direction due to clastic force of the reed valve portion 1412b to close the suction port 1411a. At this time, the first stopper portion 1418a and the second stopper portion 1418b each included in the suction valve stopper 1413 push the reed valve portion 1412b of the suction valve 1412 in a closing direction by accumulated elastic force. Thus, the reed valve portion 1412b of the suction valve 1412 quickly closes the suction port 1411a. Accordingly, as compressed refrigerant may be blocked from being leaked, compression efficiency may be enhanced. At the same time, as the first stopper portion 1418a and the second stopper portion 1418b each included in the suction valve stopper 1413 is configured to have a cantilever shape, the first stopper portion 1418a and the second stopper portion 1418b each included in the suction valve stopper 1413 is pressed by the piston 132 to be unbent in stage (d) in which the piston 132 reaches the top dead center. Accordingly, volumetric efficiency may be increased by minimizing dead volume between the front-end surface 132a of the piston 132 and the suction valve stopper 1413.

In some examples, referring to FIG. 9, when the reciprocating compressor performs low load operation, the piston 132 performs a reciprocating motion at a low speed. Accordingly, the reed valve portion 1412b of the suction valve 1412 is bent relatively slightly to open or close the suction port 1411a.

For example, in stage a in which the piston 132 begins to move backward and the front-end surface 132a of the piston 132 is slightly away from a top dead center, the reed valve portion 1412b of the suction valve 1412 is slightly bent. However, as the first contact portion 1418a3 and the second contact portion 1418b3 each included the suction valve stopper 1413 are respectively spaced apart from the suction valve 1412 by a preset distance, the reed valve portion 1412b of the suction valve 1412 may not be in contact with the first contact portion 1418a3 and the second contact portion 1418b3 of the suction valve stopper 1413. Accordingly, at the beginning of the backward movement of the piston 132, the reed valve portion 1412b of the suction valve 1412 may be quickly opened to quickly suction refrigerant into the compression chamber 130a.

In some examples, in stage b in which the piston 132 moves further backward and the front-end surface 132a of the piston 132 becomes further away from a top dead center, the reed valve portion 1412b of the suction valve 1412 is further bent. However, as the reed valve portion 1412b of the suction valve 1412 is not yet in contact with the first stopper portion 1418a and the second stopper portion 1418b each included in the suction valve stopper 1413, a state in which an opening operation is not limited is be maintained. Accordingly, even when the piston 132 moves further backwards, the reed valve portion 1412b of the suction valve 1412 continues to be opened so that refrigerant may be smoothly suctioned into the compression chamber 130a.

In some examples, the piston 132 moves further backward, and the reed valve portion 1412b of the suction valve 1412 is bent more greatly until stage (c) in which the front-end surface 132a of the piston 132 reaches a bottom dead center. However, in this stage, the reed valve portion 1412b of the suction valve 1412 does not yet come into contact with the first contact portion 1418a3 and the second contact portion 1418b3, or even when in contact therewith, the reed valve portion 1412b of the suction valve 1412 is in weak contact with the first contact portion 1418a3 and the second contact portion 1418b3. Thus, the reed valve portion 1412b is opened smoothly. Accordingly, even when the piston 132 moves backwards to a bottom dead center, the reed valve portion 1412b of the suction valve 1412 continues to be opened so that refrigerant may be smoothly suctioned into the compression chamber 130a.

In some examples, when the piston 132 moves forwards in an opposite direction (discharge stroke), the reed valve portion 1412b of the suction valve 1412 rotates in the opposite direction due to elastic force of the reed valve portion 1412b to close the suction port 1411a. At this time, when being opened, the reed valve portion 1412b of the suction valve 1412 is not in a state of being strongly bent. Thus, the reed valve portion 1412b is quickly unbent to close the suction port 1411a. At the same time, as the first stopper portion 1418a and the second stopper portion 1418b each included in the suction valve stopper 1413 is configured to have a cantilever shape, the first stopper portion 1418a and the second stopper portion 1418b each included in the suction valve stopper 1413 is pressed by the piston 132 to be unbent in stage d in which the piston 132 reaches the top dead center. Accordingly, volumetric efficiency may be increased by minimizing dead volume between the front-end surface 132a of the piston 132 and the suction valve stopper 1413.

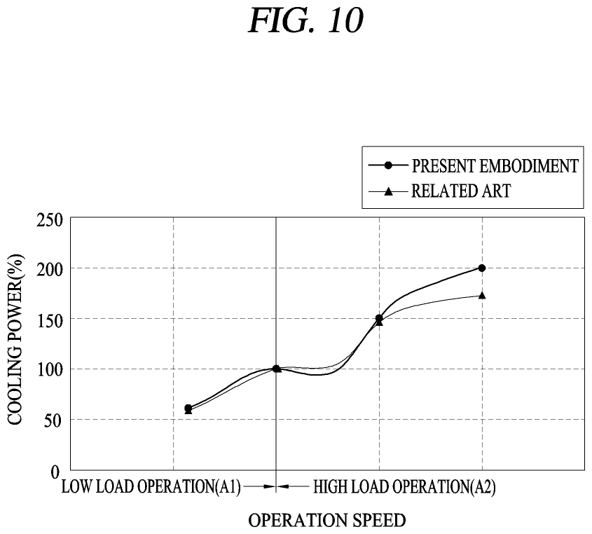

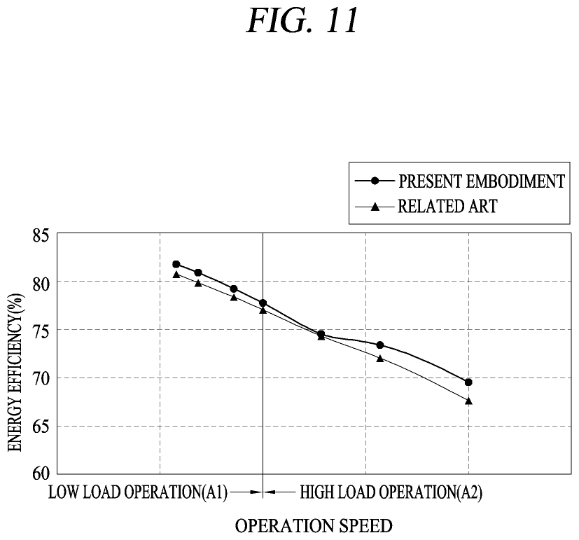

FIG. 10 is a graph showing a result of comparing a change in cooling power in each operational range during application of the suction valve stopper with that in the related art. FIG. 11 is a graph showing a result of comparing an efficiency change in each operational range during application of the suction valve stopper with that in the related art.

Referring to FIG. 10, it may be understood that when the suction valve stopper 1413 is applied, cooling power is improved in a high load operation area A2 compared to a low load operation area A1. In other words, in the high load operation area A2, cooling power is improved in a case when the suction valve stopper 1413 made of an elastic member like is applied, compared to other cases in related art, e.g., a case when a valve plate configured as a rigid body is equipped on the front-end surface 1315a of the cylinder 1315, or a case when a valve accommodating groove is disposed in the front-end surface 1315a of the cylinder 1315. It may be understood that, compared to the related art, cooling power gradually increases up to about 12% in the high load operation area A2, particularly when an operation speed is high. Thus, it may be understood that, when the suction valve stopper 1413 is made of a material and/or shape having elastic force like, since an opening amount of the suction valve 1412 may be sufficiently secured, cooling power may be greatly increased in the high load operation area A2.

In some examples, referring to FIG. 11, it may be understood that energy efficiency is improved in the low load operation area A1, as well as in the high load operation area A2 when the suction valve stopper 1413 is applied. An increase in energy efficiency is a particularly important factor in the low-load operation area A1. It may be understood that energy efficiency improves by approximately 1% in a case when the suction valve stopper 1413 made of an elastic member is applied by being bent to be spaced apart from the suction valve 1412 like, compared to other cases (the related art), e.g., a case when a rigid valve plate is equipped on a front-end surface 1315a of the cylinder 1315, or when a valve accommodating groove is disposed in the front-end surface 1315a of the cylinder 1315. This also applies to the high-load operation area A2, and it may be understood that energy efficiency is improved when an operation speed is high, compared to the related art. Thus, in some implementations, when the suction valve stopper 1413 having elastic force is disposed to be spaced apart from the suction valve 1412, an opening amount of the suction valve 1412 may be sufficiently secured to thereby increase energy efficiency in the low load operation area A1 and the high operation area A2.

Hereinafter, a case when another implementation of a suction valve stopper is present is described.

That is, in the above-described implementation, a stopper portion of a suction valve stopper is disposed on both sides of a reed valve portion of a suction valve in a longitudinal direction. However, in some cases, only one stopper portion of a suction valve stopper may be disposed on one side of a reed valve portion of a suction valve.

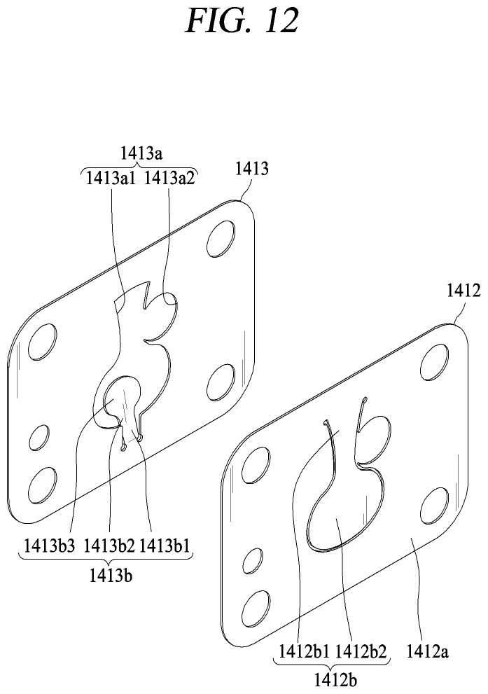

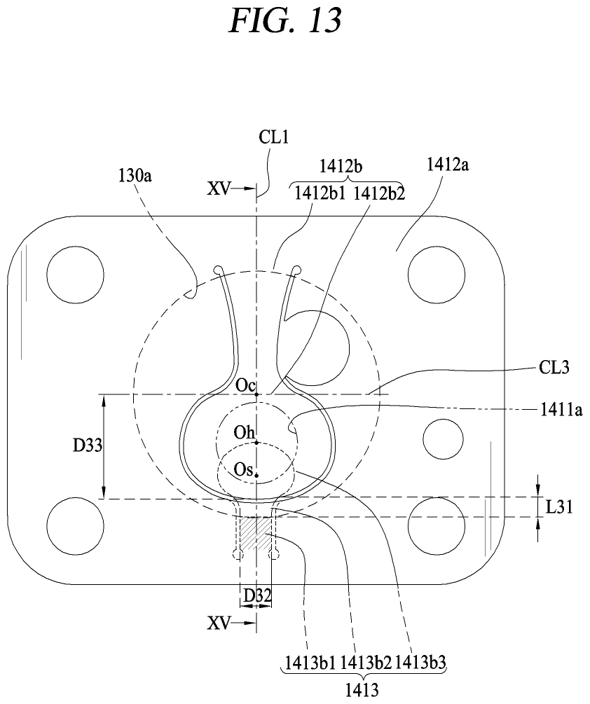

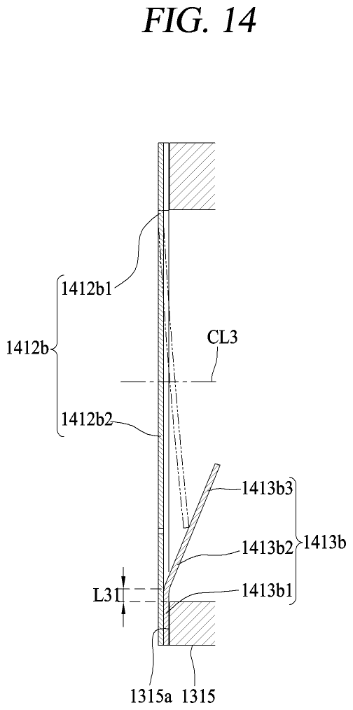

FIG. 12 is a perspective view illustrating another implementation of a suction valve stopper. FIG. 13 is a plan view illustrating a cylinder into a suction valve and the suction valve stopper each shown in FIG. 12 are assembled. FIG. 14 is a sectional view taken along line “XV-XV” of FIG. 13.

Referring back to FIG. 2, a basic configuration of the reciprocating compressor including the suction valve stopper 1413 and an operational effect of the basic configuration are similar to those in the implementation described above. For example, the reciprocating compressor may include a piston 132 disposed inside a cylinder 1315 and configured to perform a reciprocating motion due to a motor unit 120 and define a compression chamber 130a inside the cylinder 1315, and a suction/discharge unit 140 disposed on a front-end surface 1315a of the cylinder 1315 and configured to suction refrigerant into the compression chamber 130a or discharge the refrigerant from the compression chamber 130a according to the reciprocating motion of the piston 132. The suction/discharge unit 140 may include a valve assembly 141, a suction muffler 142, and a discharge muffler 143, and the valve assembly 141 may include a valve plate 1411, a suction valve 1412, and the suction valve stopper 1413, a discharge valve 1414, a discharge valve stopper 1415, and a discharge cover 1416.

The valve plate 1411 may have a suction port 1411a eccentrically disposed with respect to a third center line CL3 passing through a radial center Oc of the compression chamber 130a. A reed valve portion 1412b configured to open or close the suction port 1411a may be disposed in the suction valve 1412 to have a cantilever shape. The suction valve stopper 1413 may be made of an elastic member and disposed to be bent toward the suction valve 1412. Accordingly, when the reed valve portion 1412b of the suction valve 1412 may be greatly bent and opened, the reed valve portion 1412b of the suction valve 1412 may be brought into contact with a stopper portion 1413b of the suction valve stopper 1413 to be elastically opened within a proper range or limited not to be excessively opened.

In some implementations, as shown in FIG. 12, the suction valve stopper 1413 may include a stopper fixing portion 1413a and one stopper portion 1413b. In some implementations, as shown in FIG. 4, the plurality of stopper portions 1418a and 1418b are disposed on both sides of the stopper fixing portion 1413a, respectively, with reference to the first center line CL1. Referring to FIG. 13, one stopper portion 1413b may extend longitudinally from the stopper fixing portion 1413a.

Referring to FIGS. 12 to 14, the stopper portion 1413b may include a fixing portion 1413b1, a bent portion 1413b2, and a contact portion 1413b3.

The fixing portion 1413b1 may extend from an inner circumferential surface of the stopper fixing portion 1413a and be fixed to a front-end surface 1315a of the cylinder 1315 in a radial outer periphery of the compression chamber 130a. The bent portion 1413b2 may extend from the fixing portion 1413b1 toward a radial center of the suction port 1411a and be bent in a radial interior of the compression chamber 130a in a direction away from the reed valve portion 1412b of the suction valve 1412. The contact portion 1413b3 may extend from the bent portion 1413b2 to constitute a free end. The fixing portion 1413b1, the bent portion 1413b2, and the contact portion 1413b3 may be configured to be identical or similar to the first and second fixing portions 1418a1 and 1418b1, the first and second bent portions 1418a2 and 1418b2, and the first and second contact portions 1418a3 and 1418b3 in the above-mentioned implementation, respectively. Accordingly, a description about the fixing portion 1413b1, the bent portion 1413b2, and the contact portion 1413b3 will be replaced by the description about those in the above-mentioned implementation.

In some implementations, the stopper portion 1413b of the suction valve stopper 1413 may extend longitudinally along a longitudinal direction of the reed valve portion 1412b of the suction valve 1412. In other words, the stopper portion 1413b may extend longitudinally from an inner circumferential surface of the stopper fixing portion 1413a along the first center line CL1, and the fixing portion 1413b1 of the stopper portion 1413b may be located on a side in which an opening/closing end 1412b2 of the reed valve portion 1412b of the suction valve 1412 is located, with reference to a second center line CL2 perpendicular to the first center line CL1. Accordingly, the bent portion 1413b2 and the contact portion 1413b3 of the stopper portion 1413b may be disposed to extend from the suction port 1411a of the stopper fixing portion 1413a toward the fixed end 1412b1 of the reed valve portion 1412b. Thus, while only one stopper portion 1413b is disposed, the reed valve portion 1412b of the suction valve 1412 may be symmetrically supported to provide stable support. CL2 may define a longitudinal axis of the suction valve stopper 1413.

In some implementations, the stopper portion 1413b may be disposed on a side in which the suction port 1411a eccentric with respect to a radial center Oc of the compression chamber 130a is located. Thus, a length L31 of the bent portion 1413b2 may be configured to be smaller than each of a length L3 of the bent portion 1418a2 and a length L3 of the bent portion 1418b2 described with reference to the above-described implementation. Accordingly, rigidity of the stopper portion 1413b is increased, and thus, the reed valve portion 1412b of the suction valve 1412 may be stably supported using only one stopper portion 1413b.

In this case, a width D32 of the bent portion 1413b2 may be configured to be smaller than each of a width D2 of the bent portion 1418a2 and a width D2 of the bent portion 1418b2 in the above-described implementation. For example, the width D32 of the bent portion 1413b2 may be disposed to be smaller than a width of the fixing portion 1413b1. Accordingly, while the length L31 of the bent portion 1413b2 is disposed to be small, rigidity of the bent portion 1413b2 may be appropriately lowered to secure an opening amount of the suction valve 1412.

In addition, a radial center Os of the contact portion 1413b3 may be disposed eccentrically toward another end of the reed valve portion 1412b with respect to a radial center Oh of the suction port 1411a, i.e., toward the opening/closing end 1412b2. Accordingly, a space between the suction valve 1412 and the suction valve stopper 1413 may be sufficiently secured to prevent an excessive increase in support force with respect to the suction valve 1412 at a beginning of opening. By doing so, the suction valve 1412 may be opened smoothly, and thus, an amount of refrigerant to be suctioned may be increased.

Additionally, a width D33 of the contact portion 1413b3 may be configured to be greater than the width D32 of the bent portion 1413b2, for example, to have a circular shape. Accordingly, although one only one contact portion 1413b3 is present, the reed valve portion 1412b of the suction valve 1412 may be stably supported. However, the contact portion 1413b3 may be also disposed to have a semicircular shape like in the above-described implementation of FIG. 3, and disposed to symmetrical with respect to the first center line CL1. In this case, the contact portion 1413b3 may be disposed longitudinally along the second center line CL2 perpendicular to the first center line CL1 to stably support the reed valve portion 1412b of the suction valve 1412.

As described above, when the suction valve stopper 1413 is configured as one stopper portion 1413b, the suction valve stopper 1413 may be easily machined by simplifying a shape of the stopper portion 1413b.

Also, in this case, as the stopper portion 1413b is disposed to have elastic force, cooling power may be increased by sufficiently securing an opening amount of the suction valve 1412 in low-load operation as well as in high-load operation like the above-described implementation. At the same time, during high load operation, a damage to the suction valve 1412 may be prevented by appropriately limiting an opening amount of the reed valve portion 1412b.

In addition, as the stopper portion 1413b is bent in a direction away from the reed valve portion 1412b of the suction valve 1412, an opening operation of the reed valve portion 1412b is not limited during an initial opening of the suction valve 1412 in low load operation as well as in high load operation. Accordingly, the suction valve 1412 may be opened quickly and energy efficiency in low load operation may be increased.

In addition, when the piston 132 moves forwards (discharge stroke), the reed valve portion 1412b of the suction valve 1412 is unbent along the piston 132 to close the suction port 1411a. At this time, the stopper portion 1413b of the suction valve stopper 1413 is also pushed by the piston 132 and unbent together with the reed valve portion 1412b of the suction valve 1412 to thereby define a same plane as the front-end surface 1315a of the cylinder 1315. Accordingly, the front-end surface 132a of the piston 132 may move forward to the front-end surface 1315a of the cylinder 1315, thereby minimizing generation of dead volume in the compression chamber 130a.

In addition, when the suction valve 1412 is closed as the piston 132 moves forwards (discharge stroke), the reed valve portion 1412b of the suction valve 1412 may be pushed by the stopper portion 1413b of the suction valve stopper 1413 having elastic force and closed. Thus, a closing speed of the suction valve 1412 may be enhanced to increase compression efficiency.

In some implementations, the stopper portion 1413b of the suction valve stopper 1413 may extend from a position eccentric with respect to the first center line CL1 toward the reed valve portion 1412b of the suction valve 1412. In other words, the stopper portion 1413b of the suction valve stopper 1413 may be disposed to be inclined with reference to the first center line CL1. In this case, as a length of the stopper portion 1413b extends further, an opening amount of the reed valve portion 1412b may be expanded, thereby improving cooling power.

Hereinafter, still another implementation of a suction valve stopper is described.

That is, in the above-described implementations, a suction valve stopper is fastened to a cylinder together with a suction valve. However, in some cases, a suction valve stopper may be disposed individually and fixed to a cylinder.

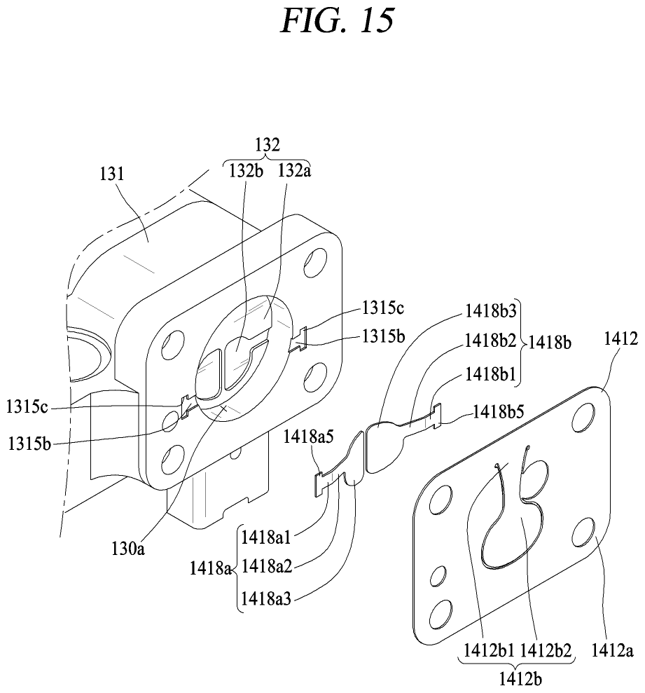

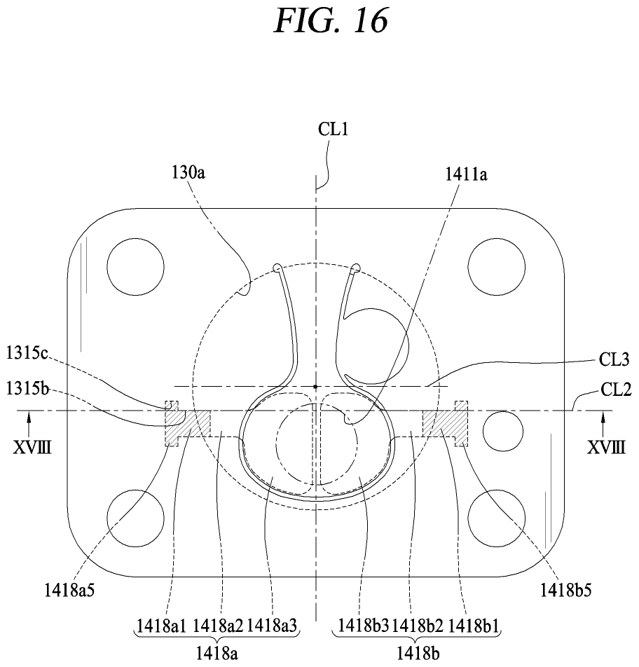

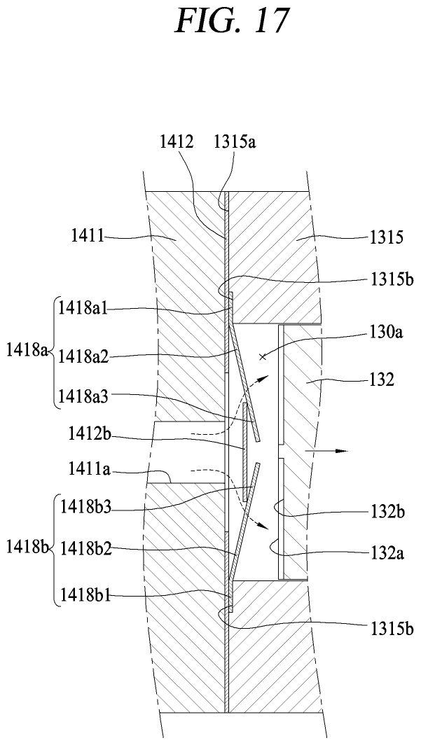

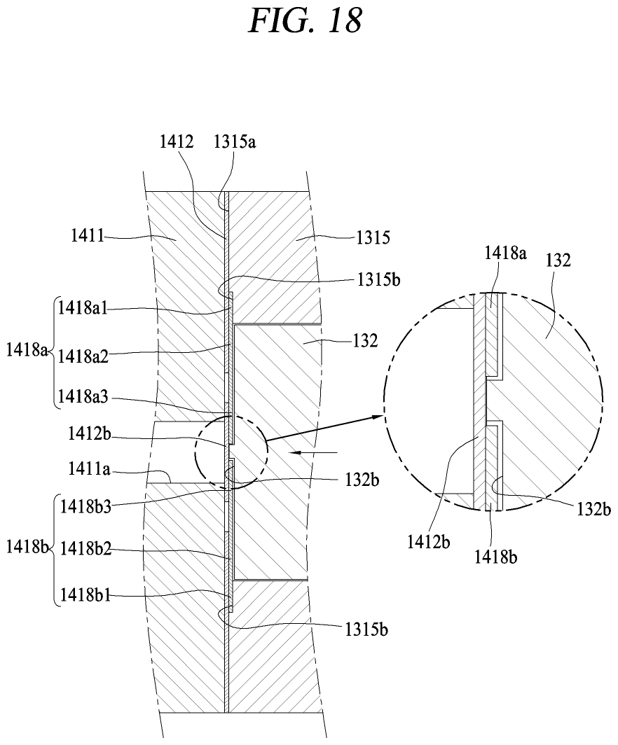

FIG. 15 is a perspective view illustrating still another implementation of the suction valve stopper. FIG. 16 is a plan view illustrating a cylinder into which a suction valve and the suction valve stopper each shown in FIG. 15 are assembled. FIGS. 17 and 18 are sectional views taken along line “XVIII-XVIII” of FIG. 16, wherein FIG. 17 illustrates a suction stroke of a piston and FIG. 18 illustrates a discharge stroke of the piston.

Referring back to FIG. 2, a basic configuration of a reciprocating compressor including the suction valve stopper 1413 and an operational effect of the basic configuration are similar to those in the implementation described above. For example, the reciprocating compressor may include a piston 132 disposed inside a cylinder 1315 and configured to perform a reciprocating motion due to a motor unit 120 and define a compression chamber 130a inside the cylinder 1315, and a suction/discharge unit 140 disposed on a front-end surface 1315a of the cylinder 1315 and configured to suction refrigerant into the compression chamber 130a or discharge the refrigerant from the compression chamber 130a according to the reciprocating motion of the piston 132. The suction/discharge unit 140 may include a valve assembly 141, a suction muffler 142, and a discharge muffler 143, and the valve assembly 141 may include a valve plate 1411, a suction valve 1412, and a suction valve stopper 1413, a discharge valve 1414, a discharge valve stopper 1415, and a discharge cover 1416.

The valve plate 1411 may have a suction port 1411a eccentrically disposed with respect to a third center line CL3 passing through a radial center Oc of the compression chamber 130a. A reed valve portion 1412b configured to open or close the suction port 1411a may be disposed in the suction valve 1412 to have a cantilever shape. The suction valve stopper 1413 may be made of an elastic member and disposed to be bent toward the suction valve 1412. Accordingly, when the reed valve portion 1412b of the suction valve 1412 may be greatly bent and opened, the reed valve portion 1412b of the suction valve 1412 may be brought into contact with a stopper portion 1413b of the suction valve stopper 1413 to be elastically opened within a proper range or limited not to be excessively opened.

However, unlike the above-described implementations, the suction valve stopper 1413 may be inserted and fixed into the cylinder 1315. In other words, the stopper fixing portion 1413a disposed in the above-described implementations may be excluded, and the suction valve stopper 1413 may be configured as only a single stopper portion 1413b. In this case, a plurality of suction valve stoppers 1413 may be included like the implementation of FIG. 3, and disposed on both sides, respectively, with reference to a first center line CL1. Alternatively, one suction valve stopper 1413 may be included and disposed on the first center line CL1, like the implementation of FIG. 12. Hereinafter, an example in which a plurality of stopper portions 1413b are disposed on both sides, respectively, with reference to the first center line CL1, like the implementation of FIG. 3, is described.

Referring to FIGS. 15 to 18, the suction valve stopper 1413 includes a first stopper portion 1418a and a second stopper portion 1418b. The first stopper portion 1418a and the second stopper portion 1418b may be configured to be symmetrical to each other and disposed on both sides, respectively, with reference to the first center line CL1. Hereinafter, the first stopper portion 1418a is mainly described, and a description about the second stopper portion 1418b is replaced by the description about the first stopper portion 1418a.

The first stopper portion 1418a may include a first fixing portion 1418a1, a first bent portion 1418a2, and a first contact portion 1418a3. The first fixing portion 1418a1, the first bent portion 1418a2, and the first contact portion 1418a3 may be configured to be identical or almost similar to the first fixing portion 1418a1, the first bent portion 1418a2, and the first contact portion 1418a3 each described above with reference to the implementation of FIG. 3.

Accordingly, a description about the first fixing portion 1418a1, the first bent portion 1418a2, and the first contact portion 1418a3 will be replaced by the description with reference to the above-described implementation of FIG. 3.

However, in the present implementation, a stopper fixing portion is excluded from the suction valve stopper 1413 so that a single first stopper portion 1418a is disposed individually, and the first fixing portion 1418a1 of the first stopper portion 1418a may be inserted and fixed into a front-end surface 1315a of a cylinder 1315. For example, a first stopper fixing groove 1315b may be disposed in the front-end surface 1315a of the cylinder 1315, and the first fixing portion 1418a1 of the suction valve stopper 1413 may be inserted and fixed into the first stopper fixing groove 1315b. In this case, when being inserted into the first stopper fixing groove 1315b, the first fixing portion 1418a1 of the suction valve stopper 1413 may be fixed by being pressed by the valve plate 1411 together with the suction valve 1412, or fixed by performing welding. Accordingly, even when the stopper fixing portion is excluded from the suction valve stopper 1413, the first fixing portion 1418a1 of the suction valve stopper 1413 may be stably fixed between the cylinder 1315 and the suction valve 1412. By doing so, a material cost of the suction valve stopper 1413 may be reduced in correspondence with the exclusion of a stopper fixing portion from the suction valve stopper 1413.

Additionally, a width and a depth of the first stopper fixing groove 1315b may be configured to correspond to a width and a depth of the first fixing portion 1418a1. Accordingly, while the first stopper fixing groove 1315b may be disposed in the cylinder 1315, dead volume resulting therefrom may be minimized.

In addition, a first support protrusion 1418a5 is disposed at an end portion of the first fixing portion 1418a1, and a first support protrusion insertion groove 1315c may be disposed in the first stopper fixing groove 1315b so that the first support protrusion 1418a5 is inserted into the first support protrusion insertion groove 1315c. In other words, the first support protrusion 1418a5 may extend to have a step portion on one side surface and/or both side surfaces of the first fixing portion 1418a1 in a direction intersecting a longitudinal direction of the suction valve stopper 1413, and the first support protrusion insertion groove 1315c may extend to have a step portion on one side surface and/or both side surfaces of the first stopper fixing groove 1315b in a direction intersecting a longitudinal direction of the suction valve stopper 1413. Accordingly, as shown in FIG. 17, when the piston 132 moves backward (suction stroke), the first support protrusion 1418a5 of the suction valve stopper 1413 may be inserted into the first support protrusion insertion groove 1315c in the cylinder 1315 to be radially supported. Thus, even when the first stopper portion 1418a constituting the suction valve stopper 1413 is disposed individually without a stopper fixing portion, the first stopper portion 1418a may be stably fixed to the front-end surface 1315a of the cylinder 1315.

Additionally, a first stopper insertion groove 132b may be disposed in the front-end surface 132a of the piston 132 so that the first contact portion 1418a3 of the suction valve stopper 1413 is inserted into the first stopper insertion groove 132b. In other words, the front-end surface 132a of the piston 132 may be disposed flatly, and the first stopper insertion groove 132b recessed in correspondence with an area and a thickness of the first contact portion 1418a3 may be disposed in a portion corresponding to the first contact portion 1418a3 of the suction valve stopper 1413. Accordingly, as shown in FIG. 18, when the piston 132 moves forwards (discharge stroke), the piston 132 may move forward to the front-end surface 1315a of the cylinder 1315, the front-end surface 1315a being in contact with the suction valve 1412. By doing so, while the suction valve stopper 1413 includes a single first stopper portion 1418a disposed individually, generation of dead volume resulting therefrom may be suppressed.

What is claimed is:

1. A reciprocating compressor comprising:
a shell that defines an inner space therein;
a driving motor disposed in the inner space of the shell, the driving motor comprising a rotor;
a drive shaft coupled to the rotor of the driving motor;
a piston coupled to the drive shaft and configured to perform a reciprocating motion;
a cylinder that accommodates the piston and defines a compression chamber together with the piston inserted in the cylinder, wherein the piston is configured to perform the reciprocating motion relative to the cylinder;
a valve plate that is coupled to a front-end surface of the cylinder and faces the piston, the valve plate defining a suction port and a discharge port that are configured to fluidly communicate with the compression chamber;
a suction valve disposed between the cylinder and the valve plate, the suction valve comprising a reed valve portion configured to open and close the suction port based on an end of the reed valve portion moving relative to another end of the reed valve portion; and
a suction valve stopper disposed between the suction valve and the cylinder, the suction valve stopper being made of an elastic member and configured to interfere with the reed valve portion to thereby limit an opening amount of the reed valve portion.

2. The reciprocating compressor of claim 1, wherein a rigidity of the suction valve stopper is greater than or equal to a rigidity of the suction valve.

3. The reciprocating compressor of claim 1, wherein the suction valve stopper comprises at least one stopper portion that extends toward a radial center of the suction port and overlaps with a side surface of the reed valve portion, and
wherein at least a portion of the at least one stopper portion is bent in a direction away from the reed valve portion and spaced apart from the reed valve portion.

4. The reciprocating compressor of claim 3, wherein the at least one stopper portion comprises:
a fixing portion fixed to the front-end surface of the cylinder and disposed at a radial outer periphery of the compression chamber;
a bent portion that extends from the fixing portion toward the radial center of the suction port and is bent toward the compression chamber in the direction away from the reed valve portion; and
a contact portion that extends from the bent portion and is configured to contact the reed valve portion based on the reed valve portion being opened, and
wherein the bent portion is disposed radially between an inner circumferential surface of the compression chamber and an outer circumferential surface of the reed valve portion.

5. The reciprocating compressor of claim 4, wherein a distance from the bent portion to an end of the contact portion is less than a length of the reed valve portion.

6. The reciprocating compressor of claim 4, wherein the suction valve stopper defines a valve accommodating portion that faces the reed valve portion and passes through the suction valve stopper, and
wherein the contact portion is accommodated in the valve accommodating portion.

7. A reciprocating compressor comprising:
a piston;
a cylinder that accommodates the piston and defines a compression chamber together with the piston inserted in the cylinder, wherein the piston is configured to reciprocate relative to the cylinder;
a valve plate that is coupled to a front-end surface of the cylinder and faces the piston, the valve plate defining a suction port and a discharge port that are configured to fluidly communicate with the compression chamber;
a suction valve comprising (i) a valve fixing portion disposed between the cylinder and the valve plate and coupled to the cylinder and (ii) a reed valve portion configured to open and close the suction port, the reed valve portion having a first end extending from the valve fixing portion and a second end configured to open and close the suction port; and
a suction valve stopper disposed between the suction valve and the cylinder and configured to limit an opening amount of the suction valve,
wherein the suction valve stopper comprises:
a stopper fixing portion coupled to the cylinder together with the valve fixing portion, and
at least one stopper portion that extends from the stopper fixing portion toward a radial center of the suction port and at least partially overlaps with the reed valve portion along a reciprocating direction of the piston.

8. The reciprocating compressor of claim 7, wherein the at least one stopper portion comprises:
a first stopper portion disposed at a first side of a longitudinal axis of the reed valve portion; and
a second stopper portion disposed at a second side of the longitudinal axis of the reed valve portion and spaced apart from the first stopper portion,
wherein the first stopper portion and the second stopper portion are symmetrical to each other with respect to the longitudinal axis of the reed valve portion.

9. The reciprocating compressor of claim 8, wherein the first stopper portion and the second stopper portion extend in a direction perpendicular to the longitudinal axis of the reed valve portion.

10. The reciprocating compressor of claim 8, wherein the radial center of the suction port is disposed at a position eccentric with respect to a radial center of the compression chamber,
wherein the reed valve portion extends along the longitudinal axis from an outside of the suction port toward the radial center of the suction port in a radial direction, and
wherein the first stopper portion and the second stopper portion are disposed at positions eccentric with respect to the radial center of the compression chamber in the radial direction.

11. The reciprocating compressor of claim 8, wherein the first stopper portion comprises:
a first fixing portion that extends from a first side of the stopper fixing portion and is fixed to the front-end surface of the cylinder, the first fixing portion being disposed at a radial outer periphery of the compression chamber;
a first bent portion that extends from the first fixing portion toward the radial center of the suction port and is bent toward the compression chamber in a direction away from the reed valve portion; and
a first contact portion that extends from the first bent portion and is configured to contact one side of the reed valve portion based on the reed valve portion being opened,
wherein the second stopper portion comprises:
a second fixing portion that extends from a second side of the stopper fixing portion and is fixed to the front-end surface of the cylinder, the second fixing portion being disposed at the radial outer periphery of the compression chamber,
a second bent portion that extends from the second fixing portion toward the radial center of the suction port and is bent toward the compression chamber in the direction away from the reed valve portion, and
a second contact portion that extends from the second bent portion and is configured to contact another side of the reed valve portion based on the reed valve portion being opened, and
wherein the first fixing portion and the second fixing portion are disposed at the first side and the second side of the longitudinal axis of the reed valve portion, respectively.

12. The reciprocating compressor of claim 11, wherein a width of the first bent portion is less than or equal to a width of the first fixing portion, and
wherein a width of the second bent portion is less than or equal to a width of the second fixing portion.

13. The reciprocating compressor of claim 11, wherein a width of the first contact portion is greater than or equal to a width of the first bent portion, and
wherein a width of the second contact portion is greater than or equal to a width of the second bent portion.

14. The reciprocating compressor of claim 11, wherein the first contact portion is disposed closer to the suction port than the first bent portion in a radial direction, and
wherein the second contact portion is disposed closer to the suction port than the second bent portion in the radial direction.

15. The reciprocating compressor of claim 7, wherein the at least one stopper portion is a single stopper portion.

16. The reciprocating compressor of claim 15, wherein the radial center of the suction port is disposed at a position eccentric with respect to a radial center of the compression chamber,
wherein the reed valve portion extends longitudinally from an outside of the suction port toward the radial center of the suction port in a radial direction, and
wherein the single stopper portion is disposed at a side corresponding to the position of the suction port with respect to a center line perpendicular to a longitudinal axis of the reed valve portion.

17. The reciprocating compressor of claim 16, wherein the single stopper portion is disposed at the longitudinal axis of the reed valve portion.

18. The reciprocating compressor of claim 15, wherein the single stopper portion comprises:
a fixing portion that extends from the stopper fixing portion and is fixed to the front-end surface of the cylinder, the fixing portion being disposed at a radial outer periphery of the compression chamber;
a bent portion that extends from the fixing portion toward the radial center of the suction port and is bent toward the compression chamber in a direction away from the reed valve portion; and
a contact portion that extends from the bent portion and is configured to contact one side of the reed valve portion based on the reed valve portion being opened, and
wherein a radial center of the contact portion is disposed at a position eccentric toward another side of the reed valve portion with respect to the radial center of the suction port.

19. A reciprocating compressor comprising:
a piston;
a cylinder that accommodates the piston and defines a compression chamber together with the piston inserted in the cylinder, wherein the piston is configured to reciprocate relative to the cylinder;
a valve plate that is coupled to a front-end surface of the cylinder and faces the piston, the valve plate defining a suction port and a discharge port that are configured to fluidly communicate with the compression chamber;
a suction valve comprising (i) a valve fixing portion disposed between the cylinder and the valve plate and coupled to the cylinder and (ii) a reed valve portion configured to open and close the suction port, the reed valve portion having a first end extending from the valve fixing portion and a second end configured to open and close the suction port; and
at least one suction valve stopper disposed between the suction valve and the cylinder and configured to limit an opening amount of the suction valve,
wherein the at least one suction valve stopper is fixed to the front-end surface of the cylinder.

20. The reciprocating compressor of claim 19, wherein the at least one suction valve stopper comprises:
a fixing portion fixed to the front-end surface of the cylinder and disposed at a radial outer periphery of the compression chamber;
a bent portion that extends from the fixing portion toward a radial center of the suction port and is bent toward the compression chamber in a direction away from the reed valve portion; and
a contact portion that extends from the bent portion and is configured to contact one side of the reed valve portion based on the reed valve portion being opened, and
wherein the front-end surface of the cylinder defines a stopper fixing groove that receives the fixing portion.

21. The reciprocating compressor of claim 20, wherein the fixing portion comprises a support protrusion that extends in a direction intersecting a longitudinal axis of the suction valve stopper, and
wherein the front-end surface of the cylinder further defines a support protrusion insertion groove that extends from the stopper fixing groove and receives the support protrusion.

22. The reciprocating compressor of claim 20, wherein the front-end surface of the cylinder further defines a stopper insertion groove that receives the contact portion.

23. The reciprocating compressor of claim 19, wherein the at least one suction valve stopper comprises:
a first stopper disposed at a first side of a longitudinal axis of the reed valve portion; and
a second stopper disposed at a second side of the longitudinal axis of the reed valve portion.

24. The reciprocating compressor of claim 19, wherein the at least one suction valve stopper is a single suction valve stopper that is disposed at a longitudinal axis of the reed valve portion.
